(19) United States
(12) Patent Application Publication
(10) Pub. No.: US 2023/0141951 A1
(43) Pub. Date: May 11, 2023

(54) SECONDARY BATTERY, METHOD FOR MANUFACTURING SECONDARY BATTERY, ELECTRONIC DEVICE, AND VEHICLE

(71) Applicant: SEMICONDUCTOR ENERGY LABORATORY CO., LTD., Atsugi-shi, Kanagawa-ken (JP)

(72) Inventors: Hiroshi KADOMA, Sagamihara, Kanagawa-ken (JP); Kazutaka KURIKI, Ebina, Kanagawa-ken (JP); Yumiko YONEDA, Isehara, Kanagawa (JP); Kaori OGITA, Isehara, Kanagawa (JP); Fumiko TANAKA, Atsugi, Kanagawa (JP); Yohei MOMMA, Isehara, Kanagawa (JP); Shunpei YAMAZAKI, Setagaya, Tokyo (JP)

(21) Appl. No.: 17/905,093

(22) PCT Filed: Mar. 1, 2021
(86) PCT No.: PCT/IB2021/051669

§ 371 Date: Aug. 26, 2022

(30) Foreign Application Priority Data
Mar. 13, 2020 (JP) 2020-044156
Jul. 10, 2020 (JP) 2020-119494

(51) Int. Cl. H01M 10/0565; H01M 4/38; H01M 4/04

(52) U.S. Cl. CPC H01M 10/0565; H01M 4/386; H01M 4/0404; H01M 2004/027; H01M 2300/0082

(57) ABSTRACT

Interface contact between a polymer electrolyte and an active material layer is improved. A secondary battery with improved discharge capacity is provided. The secondary battery includes a positive electrode, a negative electrode, and an electrolyte layer between the positive electrode and the negative electrode. The positive electrode includes a positive electrode active material, a first lithium-ion conductive polymer, a first lithium salt, and a conductive material over a positive electrode current collector. The electrolyte layer includes a second lithium-ion conductive polymer and a second lithium salt. The conductive material is preferably graphene. The negative electrode preferably includes a negative electrode active material, a third lithium-ion conductive polymer, a third lithium salt, and a second conductive material over a negative electrode current collector.

### TECHNICAL FIELD

One embodiment of the present invention relates to an object, a method, or a manufacturing method. The present invention relates to a process, a machine, manufacture, or a composition of matter. One embodiment of the present invention relates to a semiconductor device, a display device, a light-emitting device, a power storage device, a lighting device, an electronic device, or a manufacturing method thereof. One embodiment of the present invention relates to, in particular, a secondary battery, a method for manufacturing a secondary battery, and an electronic device and a vehicle including a secondary battery.

Note that electronic devices in this specification mean all devices including power storage devices, and electro-optical devices including power storage devices, information terminal devices including power storage devices, and the like are all electronic devices.

### BACKGROUND ART

In recent years, a variety of power storage devices such as lithium-ion secondary batteries, lithium-ion capacitors, and air batteries have been actively developed. In particular, demand for lithium-ion secondary batteries with high output and high capacity has rapidly grown with the development of the semiconductor industry. The lithium-ion secondary batteries are essential as rechargeable energy supply sources for today’s information society.

In most of the lithium-ion batteries that are used at present, an electrolyte solution in which a lithium salt is dissolved in an organic solvent with polarity (also referred to as an organic electrolyte solution) is used. However, the organic solvent is flammable, so a secondary battery with this involves risks of combustion or ignition.

Large secondary batteries used in cars or the like have a great demand for reliability, and in particular, for safety. Thus, solid-state batteries having a solid electrolyte instead of an electrolyte solution between a positive electrode and a negative electrode have been explored. Solid electrolytes are classified roughly into inorganic solid electrolytes and organic solid electrolytes. Batteries using inorganic solid electrolytes are also referred to as all-solid-state batteries; inorganic-oxide-based electrolytes and inorganic-sulfide-based electrolytes have been actively researched and developed. Organic solid electrolytes, also referred to as polymer electrolytes, are electrolytes in which organic polymer compounds with lithium-ion conductivity are used. For example, Patent Document 1 discloses a secondary battery including an organic polymer compound as a solid electrolyte.

### Reference

### Patent Document

[Patent Document 1] Japanese Published Patent Application No. 2015-213007

### SUMMARY OF THE INVENTION

### Problems to be Solved by the Invention

A polymer electrolyte has low ion conductivity, as compared to an organic electrolyte solution, and resistance of an interface between a polymer electrolyte and an active material layer tends to be high. Thus, a polymer electrolyte secondary battery has an issue in rate characteristics, discharge capacity, cycle performance, and the like.

In view of the above, an object of one embodiment of the present invention is to improve interlayer contact between a polymer electrolyte and an active material layer. Another object is to provide a secondary battery with improved rate characteristics. Another object is to provide a secondary battery with improved discharge capacity. Another object is to provide a secondary battery with improved cycle performance. Another object is to provide a secondary battery with improved safety.

Another object of one embodiment of the present invention is to provide active material particles, a power storage device, or a manufacturing method thereof.

Note that the description of these objects does not preclude the existence of other objects. One embodiment of the present invention does not have to achieve all these objects. Other objects can be derived from the description of the specification, the drawings, and the claims.

### Means for Solving the Problems

In order to achieve the above objects, a polymer electrolyte is mixed in a positive electrode active material layer and a negative electrode active material layer, in one embodiment of the present invention. In addition, a graphene compound is used as a conductive material in the positive electrode active material layer and the negative electrode active material layer.

One embodiment of the present invention is a secondary battery including a positive electrode, a negative electrode, and an electrolyte layer between the positive electrode and the negative electrode; in which the positive electrode includes a positive electrode active material, a first lithium-ion conductive polymer, a first lithium salt, and a first conductive material over a positive electrode current collector, and the electrolyte layer includes a second lithium-ion conductive polymer and a second lithium salt.

In the above, at least one of the first lithium-ion conductive polymer and the second lithium-ion conductive polymer is preferably polyethylene oxide.

In the above, at least one of the first lithium salt and the second lithium salt preferably includes lithium, sulfur, fluorine, and nitrogen.

In the above, it is preferable that the electrolyte layer include an inorganic filler, and the inorganic filler includes aluminum oxide, titanium oxide, barium titanate, silicon oxide, lanthanum lithium titanate, lanthanum lithium zirconate, zirconium oxide, yttria-stabilized zirconia, lithium niobate, or lithium phosphate.

In the above, it is preferable that the negative electrode include a negative electrode active material, a third lithium-ion conductive polymer, a third lithium salt, and a second conductive material over a negative electrode current collector. In addition, the third lithium-ion conductive polymer is preferably polyethylene oxide. In addition, the third lithium salt preferably includes lithium, sulfur, fluorine, and nitrogen. In addition, the negative electrode active material preferably includes silicon nanoparticles.

In the above, at least one of the first conductive material and the second conductive material is preferably graphene.

In the above, the positive electrode current collector and the negative electrode current collector preferably include titanium.

Another embodiment of the present invention is method for manufacturing an electrode including a step of forming a slurry including a lithium-ion conductive polymer, a lithium salt, a conductive material, and an active material, and a step of applying the slurry to a current collector and then drying the slurry.

Another embodiment of the present invention is a method for manufacturing a secondary battery including a step of forming a first slurry including a first lithium-ion conductive polymer, a first lithium salt, a first conductive material, and a positive electrode active material, a step of forming a positive electrode by applying the slurry to a positive electrode current collector and then drying the slurry, a step of pouring a mixture including a second lithium-ion conductive polymer, a second lithium salt, and a solvent, into a container, a step of forming an electrolyte layer by heating the mixture together with the container and then drying the mixture, a step of forming a second slurry including a third lithium-ion conductive polymer, a third lithium salt, a second conductive material, and a negative electrode active material, a step of forming a negative electrode by applying the second slurry to a negative electrode current collector and then drying the second slutty, and a step of placing the negative electrode over the positive electrode with the electrolyte layer therebetween.

### Effect of the Invention

According to one embodiment of the present invention, interface contact between a polymer electrolyte and an active material layer can be improved. A secondary battery with improved rate characteristics can be provided. A secondary battery with improved discharge capacity can be provided. A secondary battery with improved cycle performance can be provided. A secondary battery with improved safety can be provided.

According to another embodiment of the present invention, active material particles, a power storage device, or a manufacturing method thereof can be provided.

Note that the description of these effects does not preclude the existence of other effects. One embodiment of the present invention does not have to have all of these effects. Other effects will be apparent from the description of the specification, the drawings, the claims, and the like, and other effects can be derived from the description of the specification, the drawings, the claims, and the like.

### BRIEF DESCRIPTION OF THE DRAWINGS

FIG. 1A to FIG. 1C are diagrams illustrating a secondary battery of one embodiment of the present invention.

FIG. 2A to FIG. 2D are diagrams illustrating a secondary battery of one embodiment of the present invention.

FIG. 3A and FIG. 3B are diagrams illustrating a manufacturing method of a secondary battery.

FIG. 4A to FIG. 4C are diagrams illustrating a coin-type secondary battery.

FIG. 5A is a top view illustrating a secondary battery, and FIG. 5B is a cross-sectional view illustrating a secondary battery.

FIG. 6A to FIG. 6C are diagrams illustrating a secondary battery.

FIG. 7A to FIG. 7D are diagrams illustrating secondary batteries.

FIG. 8A is a perspective view of a battery pack of one embodiment of the present invention, FIG. 8B is a block diagram of a battery pack, and FIG. 8C is a block diagram of a vehicle having a motor.

FIG. 9A and FIG. 9B are diagrams illustrating a power storage device of one embodiment of the present invention.

FIG. 10A and FIG. 10B are diagrams each illustrating an example of an electronic device. FIG. 10C to FIG. 10F are diagrams each illustrating an example of a transportation vehicle.

FIG. 11A is a diagram showing an electric bicycle, FIG. 11B is a diagram showing a secondary battery of the electric bicycle, and FIG. 11C is a diagram showing an electric motorcycle.

FIG. 12A to FIG. 12C are diagrams illustrating a manufacturing method of an electrolyte layer of the electrolyte layer, and FIG. 12D is a schematic cross-sectional view of a coin-type battery cell.

FIG. 13 is a photograph of an electrolyte layer fabricated in Example 1.

FIG. 14 is a cross-sectional SEM image of a positive electrode fabricated in Example 1.

FIG. 15A is a schematic cross-sectional view of a positive electrode and an electrolyte layer fabricated in Example 1, and FIG. 15B is a cross-sectional SEM image of the positive electrode and the electrolyte layer fabricated in Example 1.

FIG. 16A to FIG. 16C are diagrams illustrating lithium conduction of polyethylene oxide (PEO).

FIG. 17 is a graph showing charge and discharge characteristics of a secondary battery fabricated in Example 1.

FIG. 18 is a graph showing charge and discharge characteristics of a secondary battery fabricated in Example 1.

FIG. 19A and FIG. 19B are each a graph showing charge and discharge characteristics of a secondary battery fabricated in Example 2, and FIG. 19C is a graph showing charge and discharge cycle characteristics of the secondary batteries fabricated in Example 2.

FIG. 20A and FIG. 20B are each a graph showing charge and discharge characteristics of a secondary battery fabricated in Example 2.

FIG. 21A and FIG. 21B are each a graph showing charge and discharge characteristics of a secondary battery fabricated in Example 2, and FIG. 21C is a graph showing charge and discharge cycle characteristics of the secondary batteries fabricated in Example 2.

### MODE FOR CARRYING OUT THE INVENTION

Embodiments will be described in detail with reference to the drawings. However, the present invention is not limited to the following description, and it is readily appreciated by those skilled in the art that modes and details can be modified in various ways without departing from the spirit and the scope of the present invention. Thus, the present invention should not be construed as being limited to the description in the following embodiments. Note that in the structures of the invention described below, the same portions or portions having similar functions are denoted by the same reference numerals in different drawings, and description thereof is not repeated.

The position, size, range, and the like of each component illustrated in the drawings and the like do not represent the actual position, size, range, and the like in some cases for easy understanding of the invention. Thus, the disclosed invention is not necessarily limited to the position, size, range, or the like disclosed in drawings and the like.

Note that the term “over” or “under” in this specification and the like does not necessarily mean that a component is placed directly over and in contact with or directly under and in contact with another component. For example, the expression “active material layer B over current collector A” does not necessarily mean that the active material layer B is formed on and in direct contact with the current collector A, and does not exclude the case where another component is provided between the current collector A and the active material B.

Note that ordinal numbers such as “first” and “second” in this specification and the like are used in order to avoid confusion among components and do not denote the priority or the sequence such as the sequence of steps or the stacking sequence. A term without an ordinal number in this specification and the like might be provided with an ordinal number in the scope of claims in order to avoid confusion among components. Furthermore, a term with an ordinal number in this specification and the like might be provided with a different ordinal number in the scope of claims. Furthermore, even when a term is provided with an ordinal number in this specification and the like, the ordinal number might be omitted in the scope of claims and the like.

In this specification and the like, an example in which a lithium metal is used as a counter electrode in a secondary battery using a positive electrode and a positive electrode active material of one embodiment of the present invention is described in some cases; however, the secondary battery of one embodiment of the present invention is not limited to this example. Another material such as graphite or lithium titanate may be used as a negative electrode, for example.

In this specification and the like, an electrolyte layer refers to a region that electrically insulate a positive electrode from a negative electrode and that has lithium ion conductivity.

In this specification and the like, a polymer electrolyte secondary battery refers to a secondary battery in which an electrolyte layer between a positive electrode and a negative electrode contains a polymer. Polymer electrolyte secondary batteries include a dry (or intrinsic) polymer electrolyte battery and a polymer gel electrolyte battery. A polymer electrolyte secondary battery may be referred to as a semi-solid-state battery.

In this specification and the like, a semi-solid-state battery refers to a battery in which at least one of an electrolyte layer, a positive electrode, and a negative electrode includes a semi-solid-state material. The term “semi-solid-state” here does not mean that the proportion of a solid-state material is 50%. The term “semi-solid-state” means having properties of a solid, such as a small volume change, and also having some of properties close to those of a liquid, such as flexibility. A single material or a plurality of materials can be used as long as the above properties are satisfied. For example, a porous solid-state material infiltrated with a liquid material may be used.

In this specification and the like, a positive electrode and a negative electrode are collectively referred to as electrodes in some cases.

### Embodiment 1

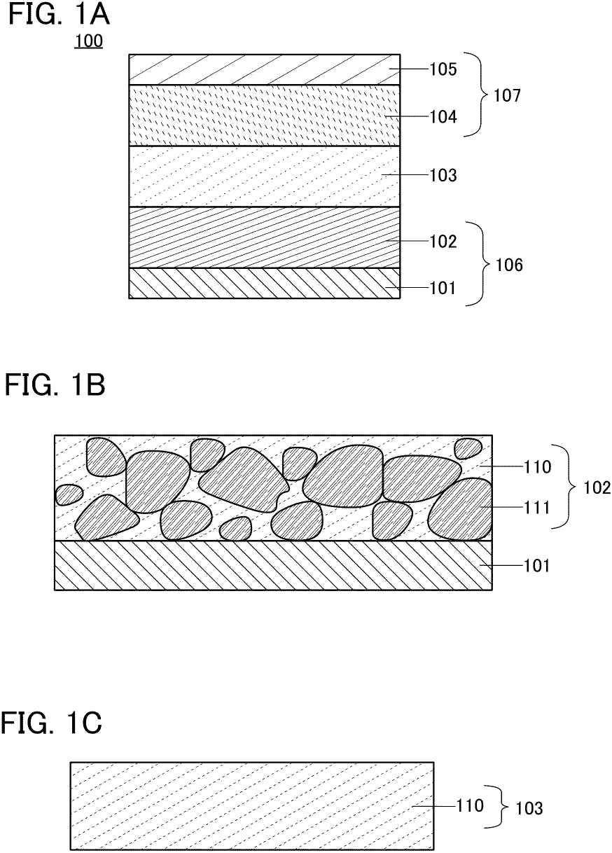

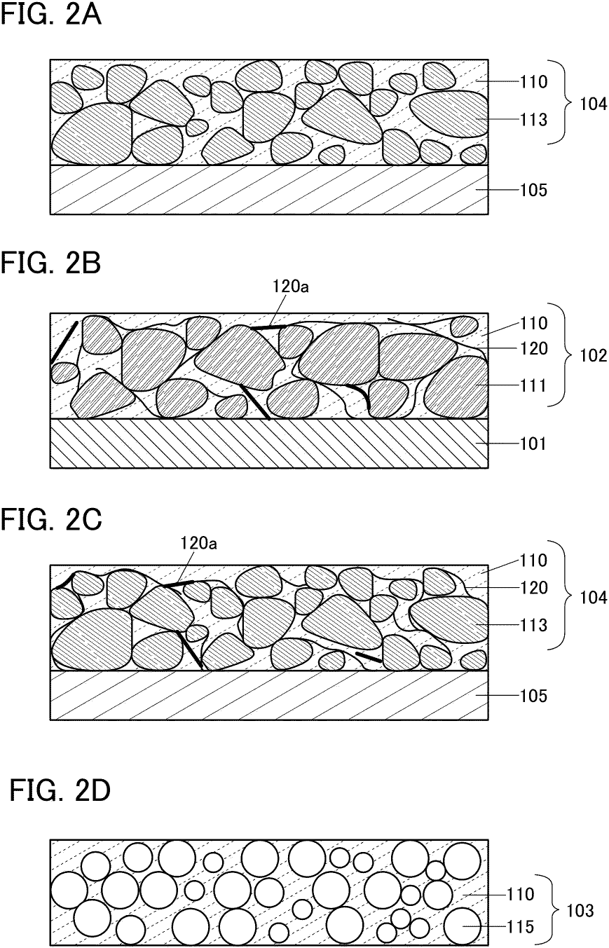

In this embodiment, an example of a secondary battery of one embodiment of the present invention will be described with reference to FIG. 1A to FIG. 2D.

FIG. 1A is a cross-sectional view of a secondary battery 100 of one embodiment of the present invention. The secondary battery 100 includes a positive electrode 106, an electrolyte layer 103, and a negative electrode 107. The positive electrode 106 includes a positive electrode current collector 101 and a positive electrode active material layer 102. The negative electrode 107 includes a negative electrode current collector 105 and a negative electrode active material layer 104.

FIG. 1B is a cross-sectional view of the positive electrode 106. The positive electrode active material layer 102 of the positive electrode 106 contains a positive electrode active material 111, an electrolyte 110, and a conductive material (not shown). The electrolyte 110 contains a lithium-ion conductive polymer and a lithium salt. It is preferable that the positive electrode active material layer 102 do not contain a binder.

FIG. 1C is a cross-sectional view of the electrolyte layer 103. The electrolyte layer 103 contains the electrolyte 110 containing a lithium-ion conductive polymer and a lithium salt.

In this specification and the like, the lithium-ion conductive polymer refers to a polymer having conductivity of cations such as lithium. More specifically, the lithium-ion conductive polymer is a high molecular compound including a polar group to which cations can coordinate. The polar group is preferably an ether group, an ester group, a nitrile group, a carbonyl group, siloxane, or the like.

As the lithium-ion conductive polymer, for example, polyethylene oxide (PEO), a derivative containing polyethylene oxide as its main chain, polypropylene oxide, polyacrylic acid ester, polymethacrylic acid ester, polysiloxane, polyphosphazene, or the like can be used.

The lithium-ion conductive polymer may have a branched or cross-linking structure. Alternatively, the lithium-ion conductive polymer may be a copolymer. The molecular weight is preferably greater than or equal to ten thousand, further preferably greater than or equal to hundred thousand, for example.

In the lithium-ion conductive polymer, lithium ions move by changing polar groups to interact with, due to the local motion (also referred to as segmental motion) of polymer chains. In PEO, for example, lithium ions move by changing oxygen to interact with, due to the segmental motion of ether chains. When the temperature is close to or higher than the melting point or softening point of the lithium-ion conductive polymer, the crystal regions are broken to increase amorphous regions, so that the motion of the ether chains becomes active and the ion conductivity increases. Thus, in the case where PEO is used as the lithium-ion conductive polymer, charging and discharging are preferably performed at higher than or equal to 60° C.

According to the ionic radius of Shannon (Shannon et al., Acta A 32 (1976) 751.), the radius of a monovalent lithium ion is 0.590 Å in the case of tetracoordination, 0.76 Å in the case of hexacoordination, and 0.92 A in the case of octacoordination. The radius of a bivalent oxygen ion is 1.35 Å in the case of bicoordination, 1.36 Å in the case of tricoordination, 1.38 Å in the case of tetracorrdination, 1.40 Å in the case of hexacoordination, and 1.42 Å in the case of octacoordination. The distance between polar groups included in adjacent lithium-ion conductive polymer chains is preferably greater than or equal to the distance that allows lithium ions and anion ions contained in the polar groups to exist stably while the above ionic radius is maintained. Furthermore, the distance between the polar groups is preferably close enough to cause interaction between the lithium ions and the polar groups. Note that the distance is not necessarily always kept constant because the segmental motion occurs as described above. The distance needs to be appropriate only when lithium ions are transferred. Note that 1 Å = 10⁻¹⁰ m.

As the lithium salt, it is possible to use a compound containing lithium and at least one of phosphorus, fluorine, nitrogen, sulfur, oxygen, chlorine, arsenic, boron, aluminum, bromine, and iodine. For example, one of lithium salts such as LiPF₆, LiN(FSO₂)₂ (lithium bis(fluorosulfonyl)imide, LiFSI), LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), LiN(C₂F₅SO₂)₂, and lithium bis(oxalate)borate (LiBOB) can be used, or two or more of these lithium salts can be used in an appropriate combination in an appropriate ratio.

It is particularly preferable to use LiFSI because favorable characteristics at low temperatures can be obtained. Note that LiFSI and LiTFSA are less likely to react with water than LiPF₆ or the like. This can relax the dew point control in fabricating an electrode and an electrolyte layer that use LiFSI. For example, the fabrication can be performed even in a normal air atmosphere, not only in an inert atmosphere of argon or the like in which moisture is excluded as much as possible or in a dry room in which a dew point is controlled. This is preferable because the productivity can be improved. When the segmental motion of ether chains is used for lithium conduction, it is particularly preferable to use a lithium salt that is highly dissociable and has a plasticizing effect, such as LiFSI and/or LiTFSA, in which case the operating temperature range can be wide.

In this specification and the like, a binder refers to a high molecular compound mixed only for binding an active material, a conductive material, and the like onto a current collector. A binder refers to, for example, a rubber material such as poly vinylidene difluoride (PVDF), styrene-butadiene rubber (SBR), styrene-isoprene-styrene rubber, butadiene rubber, or ethylenepropylene-diene copolymer; or a material such as fluorine rubber, polystyrene, polyvinyl chloride, polytetrafluoroethylene, polyethylene, polypropylene, polyisobutylene, or ethylene-propylene-diene polymer.

Since the lithium-ion conductive polymer is a high molecular compound, the positive electrode active material 111 and the conductive material can be bound onto the positive electrode current collector 101 when the lithium-ion conductive polymer is sufficiently mixed in the positive electrode active material layer 102. Thus, the positive electrode 106 can be fabricated without a binder. A binder is a material that does not contribute to charge and discharge reactions. Thus, a smaller number of binders enable higher proportion of materials that contribute to charging and discharging, such as an active material and an electrolyte. As a result, the secondary battery 100 can have higher discharge capacity, improved cycle performance, and the like.

When the positive electrode active material layer 102 and the electrolyte layer 103 both contain the electrolyte 110, interface contact between the positive electrode active material layer 102 and the electrolyte layer 103 can be improved. In addition, not only the active material at the interface between the positive electrode 106 and the electrolyte layer 103 but that inside the positive electrode 106 can contribute to charging and discharging. As a result, the secondary battery 100 can have higher rate characteristics, higher discharge capacity, improved cycle performance, and the like.

It is preferable that the electrolyte 110 contain no or extremely little organic solvent. Similarly, it is preferable that the electrolyte 110 be not gelled. When containing no or extremely little organic solvent, the secondary battery can be less likely to catch fire and ignite and thus can have higher level of safety, which is preferable. When using the electrolyte 110 containing no or extremely little organic solvent, the electrolyte layer 103 can have enough strength and thus can electrically insulate the positive electrode from the negative electrode without a separator. Since a separator is not necessary, the secondary battery can have high productivity. When using the electrolyte 110 containing an inorganic filler, the secondary battery can have higher strength and higher level of safety.

To obtain the electrolyte 110 containing no or extremely little organic solvent, the electrolyte 110 is preferably dried sufficiently. In this specification and the like, the electrolyte 110 can be regarded as being dried sufficiently when a change in the weight after drying at 90° C. under reduced pressure for one hour is within 5%.

The electrolyte 110 may contain an additive agent such as vinylene carbonate, propane sultone (PS), tert-butylbenzene (TBB), ethylene carbonate (EC), fluoroethylene carbonate (FEC), lithium bis(oxalate)borate (LiBOB), or a dinitrile compound such as succinonitrile or adiponitrile. The concentration of a material to be added is, for example, higher than or equal to 0.1 wt% and lower than or equal to 5 wt% with respect to the whole electrolyte 110.

Note that materials contained in a secondary battery, such as a lithium-ion conductive polymer, a lithium salt, a binder, and an additive agent can be identified using nuclear magnetic resonance (NMR), for example. Analysis results of Raman spectroscopy, Fourier transform infrared spectroscopy (FT-IR), time-of-flight secondary ion mass spectrometry (TOF-SIMS), gas chromatography mass spectroscopy (GC/MS), pyrolysis gas chromatography mass spectroscopy (Py-GC/MS), liquid chromatography mass spectroscopy (LC/MS), or the like can also be used for the identification. Note that analysis by NMR or the like is preferably performed after the positive electrode active material layer 102 is subjected to suspension using a solvent to separate the positive electrode active material 111 from the other materials.

FIG. 2A is a cross-sectional view of the negative electrode 107. The negative electrode active material layer 104 in the negative electrode 107 includes a negative electrode active material 113, the electrolyte 110, and a conductive material (not shown).

It is preferable that the negative electrode active material layer 104 in the negative electrode 107 do not contain a binder, as in the positive electrode 106. The use of a lithium-ion conductive polymer enables the negative electrode 107 to be fabricated without using a binder. As a result, the secondary battery 100 can have higher discharge capacity, improved cycle performance, and the like. Alternatively, a lithium metal may be used as a material that serves as the negative electrode active material 113 and the negative electrode current collector 105.

When the negative electrode active material layer 104 and the electrolyte layer 103 both contain the electrolyte 110, interface contact between the negative electrode active material layer 104 and the electrolyte layer 103 can improve. In addition, not only the active material at the interface between the negative electrode 107 and the electrolyte layer 103 but that inside the negative electrode 107 can contribute to charging and discharging. As a result, the secondary battery 100 can have higher rate characteristics, higher discharge capacity, improved cycle performance, and the like.

As the conductive material contained in the positive electrode active material layer 102 and the negative electrode active material layer 104, natural graphite, artificial graphite such as mesocarbon microbeads, or carbon fiber can be used, for example. As carbon fiber, mesophase pitch-based carbon fiber and isotropic pitch-based carbon fiber can be used, for example. As carbon fiber, carbon nanofiber and/or carbon nanotube, or the like can also be used. Carbon nanotube can be formed by, for example, a vapor deposition method. Other examples of the conductive material include carbon materials such as carbon black (e.g., acetylene black (AB)), graphite (black lead) particles, graphene, and fullerene. Alternatively, metal powder and metal fiber of copper, nickel, aluminum, silver, gold, or the like, a conductive ceramic material, or the like can be used. Note that in this specification and the like, a conductive material may also be referred to as a conductive additive or a conduction agent.

In particular, graphene and a graphene compound 120 are preferably used as the conductive materials. FIG. 2B shows a cross-sectional view of the positive electrode 106 including graphene and the graphene compound 120, and graphene and a graphene compound 120a. FIG. 2C shows a cross-sectional view of the negative electrode 107 including graphene and the graphene compound 120, and graphene and the graphene compound 120a.

A graphene compound in this specification and the like includes multilayer graphene, multi graphene, graphene oxide, multilayer graphene oxide, multi graphene oxide, reduced graphene oxide, reduced multilayer graphene oxide, reduced multi graphene oxide, or the like. A graphene compound contains carbon, has a plate-like shape, a sheet-like shape, or the like, and has a two-dimensional structure formed of a six-membered ring composed of carbon atoms. A graphene compound preferably has a curved shape. A graphene compound may also be referred to as a carbon sheet. A graphene compound preferably includes a functional group. A graphene compound may be rounded like a carbon nanofiber.

A material used in formation of the graphene compound may be mixed with the graphene compound to be used for the positive electrode active material layer 102 and the negative electrode active material layer 104. For example, particles used as a catalyst in formation of the graphene compound may be mixed with the graphene compound. As an example of the catalyst in formation of the graphene compound, particles containing any of silicon oxide (SiO₂ or SiOₓ (ₓ < 2)), aluminum oxide, iron, nickel, ruthenium, iridium, platinum, copper, germanium, and the like can be given. The median diameter (D50) of the particles used as a catalyst is preferably less than or equal to 1 µm, further preferably less than or equal to 100 nm.

A graphene compound has excellent electrical characteristics of high conductivity and excellent physical properties of high flexibility and high mechanical strength in some cases. A graphene compound has a sheet-like shape. A graphene compound has a curved surface in some cases, thereby enabling low-resistant surface contact. Furthermore, a graphene compound has extremely high conductivity even with a small thickness in some cases and thus allows a conductive path to be formed in an active material layer efficiently even with a small amount. Hence, a graphene compound is preferably used as the conductive material, in which case the area where the active material and the conductive material are in contact with each other can be increased. Note that a graphene compound preferably clings to at least a portion of an active material particle. A graphene compound preferably overlays at least a portion of an active material particle. The shape of a graphene compound preferably conforms to at least a portion of the shape of active material particles. The shape of active material particles means, for example, an uneven surface of a single active material particle or an uneven surface formed by a plurality of active material particles. A graphene compound preferably surrounds at least a portion of an active material particle. A graphene compound may have a hole.

In the case where an active material particle with a small particle diameter, e.g., 1 µm or less, is used, the specific surface area of the active material particle is large and thus more conductive paths for connecting the active material particles are needed. In such a case, it is particularly preferred that a graphene compound that can efficiently form a conductive path even with a small amount be used.

It is particularly effective to use a graphene compound, which has the above-described properties, as a conductive material of a secondary battery that needs to be rapidly charged and discharged. For example, a secondary battery for a two- or four-wheeled vehicle, a secondary battery for a drone, or the like is required to have fast charge and discharge characteristics in some cases. In addition, a mobile electronic device or the like is required to have fast charge characteristics in some cases. Fast charge and discharge may also be referred to as charge and discharge at a high rate, for example, at 1 C, 2 C, or 5 C or more.

Note that the identification of the conductive material contained in the secondary battery can be made through observation of the surface and cross section of the active material layer by SEM or TEM, for example, crystal structure analysis of the conductive material by electron diffraction and X-ray diffraction (XRD) analysis, or the like. In the case where a graphene compound is used as a conductive material, a plate-like shape, a sheet-like shape, a mesh-like shape, or other shapes can be observed in an SEM image or the like in some cases. In the case where graphene and the graphene compound 120 are multilayer graphene, multilayer graphene oxide, reduced multilayer graphene oxide, or the like, they may be observed as plate-like shapes, in a manner similar to the graphene and the graphene compound 120a in FIG. 2B and FIG. 2C, in an SEM image or the like.

Analysis results of Raman spectroscopy, energy dispersive X-ray spectroscopy (EDX), Fourier transform infrared spectroscopy (FT-IR), time-of-flight secondary ion mass spectrometry (TOF-SIMS), gas chromatography mass spectroscopy (GC/MS), pyrolysis gas chromatography mass spectroscopy (Py-GC/MS), liquid chromatography mass spectroscopy (LC/MS), or the like can also be used for the identification if the conductive material.

The electrolyte layer 103 may include an inorganic filler 115. FIG. 2D shows a cross-sectional view of the electrolyte layer 103 including the inorganic filler 115.

The lithium-ion conductive polymer included in the electrolyte layer 103 decreases in ion conductivity when crystallized, in some cases. Thus, with the inorganic filler 115, crystallization of the lithium-ion conductive polymer can be prevented. Furthermore, the strength of the electrolyte layer 103 can be increased. Even in the case where a dendrite of a lithium metal, a precipitation of a transition metal, and the like are generated on the surface of the positive electrode 106 or the negative electrode 107, the presence of the inorganic filler 115 can prevent them from growing, whereby an internal short circuit can be inhibited.

A material that does not react with the positive electrode and negative electrode materials and that is non-conducting is preferably used as the inorganic filler 115. For example, a material such as aluminum oxide, titanium oxide, silicon oxide, or barium titanate can be used. Alternatively, an inorganic solid electrolyte may be used as the inorganic filler 115. As an inorganic-oxide-based solid electrolyte, lanthanum lithium titanate (La₀.₅₁Li_{0.34}TiO_{2.94}, LLTO), lanthanum lithium zirconate (Li₇La₃Zr₂O₁₂, LLZO), Li_{1.3}Al_{0.3}Ti_{1.7}(PO₄)₃, Li_{2.9}PO_{3.3}N_{0.46}, zirconium oxide (ZrO₂), yttria-stabilized zirconia (YSZ), lithium niobate (LiNbO₃), lithium phosphate (Li₃PO₄), or the like can be used. As an inorganic-sulfide-based solid electrolyte, Li₁₀GeP₂S₁₂, Li_{3.25}Ge_{0.25}P_{0.75}S₄, Li₆PS₅Cl, Li₇P₃S₁₁, 70Li₂S—30P₂S₅, and the like can be used.

FIG. 2D shows a case where the inorganic filler 115 is a particle; however, one embodiment of the present invention is not limited to this and the inorganic filler 115 may be fibrous. For example, the inorganic filler 115 may be glass fiber, or a scale-like or porous particle.

In addition, the surface of the inorganic filler 115 may be modified. For example, the surface may be covered with a lithium compound such as lithium phosphate. The use of modified inorganic filler 115 can improve the conductivity of lithium ions in some cases.

Another solid electrolyte may be mixed into the electrolyte layer 103. For example, a sulfide-based solid electrolyte, an oxide-based solid electrolyte, or a halide-based solid electrolyte may be mixed.

Examples of the sulfide-based solid electrolyte include a thio-silicon-based material (e.g., Li₁₀GeP₂S₁₂ and Li_{3.25}Ge_{0.25}P_{0.75}S₄), sulfide glass (e.g., 70Li₂S·30P₂S₅, 30Li₂S·26B₂S₃·44LiI, 63Li₂S·38SiS₂·1Li₃PO₄, 57Li₂S·38SiS₂·5Li₄SiO₄, and 50Li₂S·50GeS₂), and sulfide-based crystallized glass (e.g., Li₇P₃S₁₁ and Li_{3.25}P_{0.95}S₄). The sulfide-based solid electrolyte has advantages such as high conductivity of some materials, low-temperature synthesis, and ease of maintaining a conduction path after charge and discharge because of its relative softness.

Examples of the oxide-based solid electrolyte include a material with a perovskite crystal structure (e.g., La_{⅔-x}Li₃ₓTiO₃), a material with a NASICON crystal structure (e.g., Li₁-_{X}AlₓTi_{2-X}(PO₄)₃), a material with a garnet crystal structure (e.g., Li₇La₃Zr₂O₁₂), a material with aLISICON crystal structure (e.g., Li₁₄ZnGe₄O₁₆), LLZO (Li₇La₃Zr₂O₁₂), oxide glass (e.g., Li₃PO₄— Li₄SiO₄ and 50Li₄SiO₄·50Li₃BO₃), and oxide-based crystallized glass (e.g., Li_{1.07}Al_{0.69}Ti_{1.46}(PO₄)₃ and Li_{1.5}Al_{0.5}Ge_{1.5}(PO₄)₃). The oxide-based solid electrolyte has an advantage of stability in the air.

Examples of the halide-based solid electrolyte include LiAlCl₄, Li₃InBr₆, LiF, LiCl, LiBr, and LiI. Moreover, a composite material in which pores of porous aluminum oxide or porous silica are filled with such a halide-based solid electrolyte can be used as the solid electrolyte.

For the positive electrode current collector 101 and the negative electrode current collector 105, a material having high conductivity such as a metal like stainless steel, gold, platinum, aluminum, copper, or titanium, or an alloy thereof can be used. It is preferable that a material used for the positive electrode current collector not dissolve at the potential of the positive electrode. Alternatively, it is possible to use an aluminum alloy to which an element that improves heat resistance, such as silicon, titanium, neodymium, scandium, or molybdenum, is added. Still alternatively, the positive electrode current collector 101 and the negative electrode current collector 105 may be formed using a metal element that forms silicide by reacting with silicon. Examples of the metal element that forms silicide by reacting with silicon include zirconium, titanium, hafnium, vanadium, niobium, tantalum, chromium, molybdenum, tungsten, cobalt, and nickel. The current collector can have a foil-like shape, a plate-like shape, a sheet-like shape, a net-like shape, a punching-metal shape, an expanded-metal shape, or the like as appropriate. Alternatively, the current collector may have a three-dimensional structure where porous substances in the form of punching metal or expanded metal are sterically stacked, with an electrode layer embedded therein. A layer of carbon black or graphene may also be included as an undercoating. The current collector preferably has a thickness of greater than or equal to 5 µm and less than or equal to 30 µm. Note that a foil-like shape refers to a thickness being greater than or equal to 1 µm and less than or equal to 100 µm, preferably greater than or equal to 5 µm and less than or equal to 30 µm.

In the case where LiFSI is used as a lithium salt, in particular, the positive electrode current collector 101 and the negative electrode current collector 105 are preferably formed using a material that is not easily corroded by LiFSI. For example, titanium and a titanium compound are not easily corroded and thus are preferable. Similarly, titanium, a titanium compound, or aluminum that is coated with carbon is also preferable.

As the positive electrode active material 111 included in the positive electrode 106, a material having a layered rock-salt crystal structure, a spinel crystal structure, or an olivine crystal structure, for example, can be used. For example, a composite oxide containing lithium and a transition metal, such as lithium cobalt oxide, lithium nickel oxide, lithium cobalt oxide in which manganese is substituted for part of cobalt, lithium cobalt oxide in which nickel is substituted for part of cobalt, lithium nickel-manganese-cobalt oxide, lithium iron phosphate, lithium ferrate, or lithium manganese oxide can be used. Lithium does not have to be included as long as the material functions as a positive electrode active material; V₂O₅, Cr₂O₅, MnO₂, or the like may be used.

As the negative electrode active material 113 included in the negative electrode 107, for example, an alloy-based material and/or a carbon-based material can be used.

For the negative electrode active material, an element that enables charge and discharge reactions by an alloying and a dealloying reaction with lithium can be used. For example, a material containing at least one of silicon, tin, gallium, aluminum, germanium, lead, antimony, bismuth, silver, zinc, cadmium, indium, and the like can be used. Such elements have higher charge and discharge capacity than carbon, and especially, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by an alloying and a dealloying reaction with lithium and a compound containing the element, for example, may be referred to as an alloy-based material.

In this specification and the like, SiO refers, for example, to silicon monoxide. Note that SiO can alternatively be expressed as SiOₓ. Here, x preferably has an approximate value of 1. For example, x is preferably greater than or equal to 0.2 and less than or equal to 1.5, further preferably greater than or equal to 0.3 and less than or equal to 1.2. Alternatively, x is preferably greater than or equal to 0.2 and less than or equal to 1.2. Still alternatively, x is preferably greater than or equal to 0.3 and less than or equal to 1.5.

An impurity element such as phosphorus, arsenic, boron, aluminum, or gallium may be added to silicon so that silicon is lowered in resistance. The negative electrode active material may be predoped with lithium.

It is preferable that the negative electrode active material be particles. For example, silicon nanoparticles can be used as the negative electrode active material. The median diameter (D50) of a silicon nanoparticle is, for example, preferably greater than or equal to 5 nm and less than 1 µm, more preferably greater than or equal to 10 nm and less than or equal to 300 nm, still more preferably greater than or equal to 10 nm and less than or equal to 100 nm.

The silicon nanoparticles may have crystallinity. The silicon nanoparticles may include a region with crystallinity and an amorphous region.

A material containing silicon, which has a plurality of crystal grains in a single particle, for example, can be used. For example, a configuration where a single particle include one or more silicon crystal grains can be used. The single particle may also include silicon oxide around the silicon crystal grain(s). The silicon oxide may be amorphous.

As a compound containing silicon, Li₂SiO₃ and Li₄SiO₄ can be used, for example. Each of Li₂SiO₃ and Li₄SiO₄ may have crystallinity, or may be amorphous.

Analysis of the compound containing silicon can be performed by XRD, a Raman spectroscopy method, EDX, an X-ray photoelectron spectroscopy method (XPS), or the like.

In the case where silicon is used, it is preferable that a graphene compound and silicon are mixed first. After that, it is preferable that lithium-ion conductive polymer be added little by little until a certain level of viscosity is obtained, then the rest of lithium-ion conductive polymer be added, followed by addition of a solvent. Taking such steps makes it easier for silicon, the graphene compound, and the lithium-ion conductive polymer to be mixed uniformly. Note that a preferable way of adding the lithium-ion conductive polymer depends on the volatility of a solvent in some cases. A preferable amount of the lithium-ion conductive polymer to be added depends on the surface areas of the graphene compound and silicon in some cases. In the case where the graphene compound is reduced, the time when the graphene compound is reduced is not particularly limited.

As the carbon-based material, graphite, graphitizing carbon (soft carbon), non-graphitizing carbon (hard carbon), carbon nanotube, graphene, carbon black, and the like may be used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of a lithium metal (greater than or equal to 0.05 V and less than or equal to 0.3 V vs. Li/Li⁺) when lithium ions are inserted into graphite (while a lithium-graphite intercalation compound is formed). For this reason, a lithium-ion secondary battery can have a high operating voltage. In addition, graphite is preferred because of its advantages such as a relatively high charge and discharge capacity per unit volume, relatively small volume expansion, low cost, and a higher level of safety than that of a lithium metal.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten oxide (WO₂), or molybdenum oxide (MoO₂) can be used.

Alternatively, as the negative electrode active material, Li_{3—x}MₓN (M is Co, Ni, or Cu) with a Li₃N structure, which is a nitride containing lithium and a transition metal, can be used. For example, Li_{2.6}Co_{0.4}N₃ is preferable because of high charge and discharge capacity (900 mAh/g and 1890 mAh/cm³).

A nitride containing lithium and a transition metal is preferably used, in which case lithium ions are contained in the negative electrode active material and thus the negative electrode active material can be used in combination with a material for a positive electrode active material that does not contain lithium ions, such as V₂O₅ or Cr₃O₈. Note that in the case of using a material containing lithium ions as a positive electrode active material, the nitride containing lithium and a transition metal can be used as the negative electrode active material by extracting the lithium ions contained in the positive electrode active material in advance.

Alternatively, a material that causes a conversion reaction can be used for the negative electrode active material; for example, a transition metal oxide that does not form an alloy with lithium, such as cobalt oxide (CoO), nickel oxide (NiO), or iron oxide (FeO), may be used. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

The secondary battery of one embodiment of the present invention preferably includes an exterior body in addition to the above-described structure. For the exterior body included in the secondary battery, a metal material such as aluminum and/or a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

This embodiment can be used in combination with the other embodiments.

### Embodiment 2

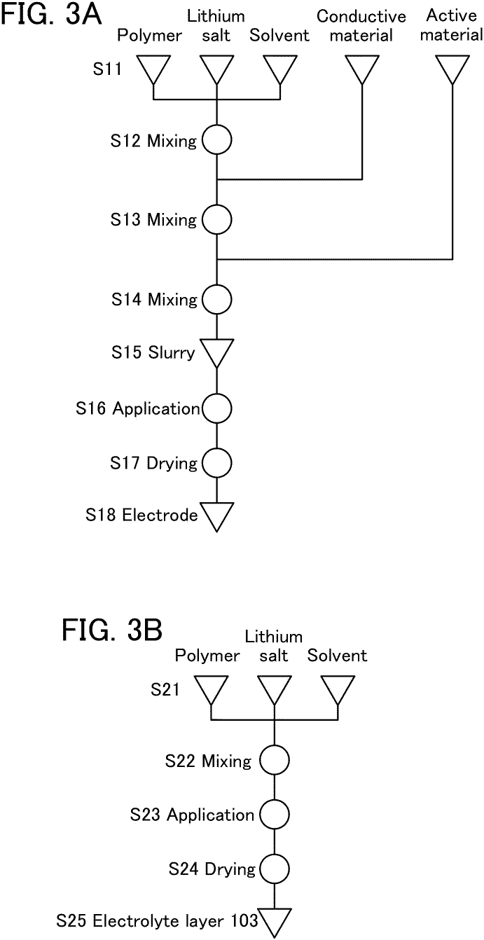

In this embodiment, an example of a manufacturing method of the secondary battery of one embodiment of the present invention will be described with reference to FIG. 3A and FIG. 3B.

FIG. 3A is a diagram illustrating a method for manufacturing the positive electrode 106 and the negative electrode 107. Hereinafter, the positive electrode 106 and the negative electrode 107 are collectively referred to as electrodes. The positive electrode active material 111 and the negative electrode active material 113 are collectively referred to as active materials.

First, as Step S11, a lithium-ion conductive polymer (polymer in the diagram), a lithium salt, a conductive material, an active material, and a solvent are prepared.

The materials described in the above embodiment can be used as the lithium-ion conductive polymer, the lithium salt, the conductive material, and the active material.

As the solvent, ketone such as acetone; alcohol such as ethanol or isopropanol; ether such as diethyl ether; dioxane; acetonitrile; N-methyl-2-pyrrolidone (NMP); or the like can be used. An aprotic solvent that hardly reacts with lithium is further preferably used. In this embodiment, acetonitrile is used.

Next, as Step S12, the lithium-ion conductive polymer, the lithium salt, and the solvent are mixed. The lithium-ion conductive polymer, the lithium salt, and the solvent can be mixed such that the ratio of the lithium-ion conductive polymer to the lithium salt is 4:1 (weight ratio), for example.

Next, as Step S13, the mixture of the lithium-ion conductive polymer, the lithium salt, and the solvent is mixed with the conductive material.

Then, as Step S14, the active material is mixed in a similar manner. These materials can be mixed such that the ratio of the active material to the conductive material and (polymer + the lithium salt) is 90:5:5 (weight ratio), for example.

In this manner, a slurry is obtained (Step S15).

A case where the conductive material and the active material are mixed in this sequence after the lithium-ion conductive polymer and the lithium salt are mixed is described above; however, one embodiment of the present invention is not limited thereto. The sequence of materials to be mixed can be replaced as appropriate. In other words, Step S12 to Step S14 can be replaced as appropriate.

Next, as Step S16, the slurry is applied to a current collector.

Next, as Step S17, the current collector and the slurry are dried to allow the solvent to be evaporated. The current collector and the slurry can be dried in a circulation drying oven at 80° C. for 30 minutes, for example. Then, a desired shape is punched out as needed.

In this manner, the electrodes are obtained (Step S18).

FIG. 3B is a diagram illustrating a method for fabricating the electrolyte layer 103.

First, as Step S21, a lithium-ion conductive polymer, a lithium salt, and a solvent are prepared. For these three, the materials described in FIG. 3A can be used.

Next, as Step S22, the lithium-ion conductive polymer, the lithium salt, and the solvent are mixed. The lithium-ion conductive polymer, the lithium salt, and the solvent can be mixed such that the ratio of the lithium-ion conductive polymer to the lithium salt is 4:1 (weight ratio).

Next, as Step S23, the mixture of the lithium-ion conductive polymer, the lithium salt, and the solvent is applied to a container for drying. As the container for drying, a petri dish made of flouroresin can be used, for example.

Next, as Step S24, the applied mixture is dried. It is preferable that the solvent be sufficiently evaporated in this step. For example, drying can take place as follows: the mixture in the container for drying is dried at 70° C., then, the mixture remained at the bottom of the container is peeled off and dried at room temperature for 12 hours under reduced pressure, and after that, the mixture is dried at 90° C. for three hours under reduced pressure.

In this manner, the electrolyte layer 103 is obtained (Step S25).

Then, the positive electrode and the negative electrode obtained in Step S18 are placed over one another with the electrolyte layer obtained in Step S25 therebetween. After that, the stack of the positive electrode, the electrolyte layer, and the negative electrode is put in an exterior body and heated at 50° C. to 100° C. inclusive for adhesion. The heating time is preferably longer than or equal to 1 hour and shorter than or equal to 10 hours, for example. Note that a secondary battery may be set up after the positive electrode, the electrolyte layer, and the negative electrode are integrated. The positive electrode, the electrolyte layer, and the negative electrode may be integrated by heat or pressure application. In the case where a material having a softening point around room temperature is used, pressure application by itself can adhere the positive electrode, the electrolyte layer, and the negative electrode to one another.

This embodiment can be used in combination with the other embodiments.

### Embodiment 3

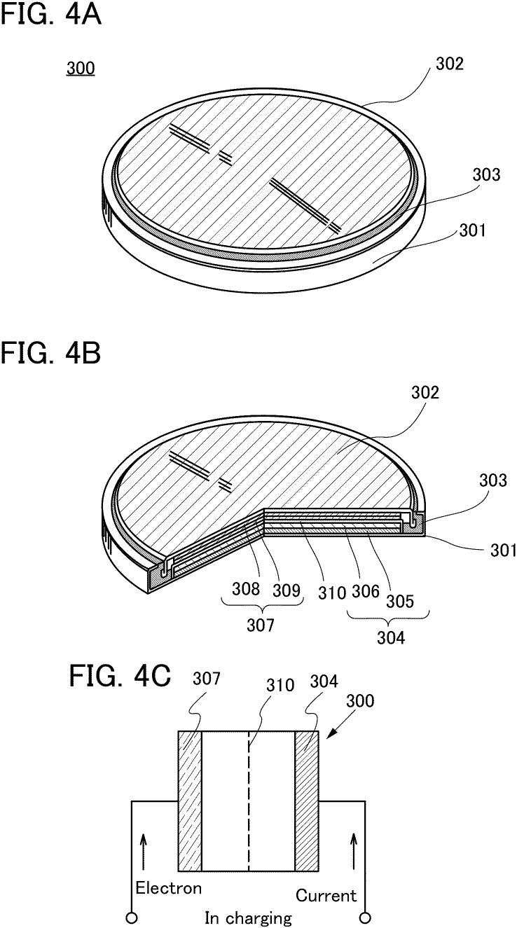

In this embodiment, examples of the shape of the secondary battery of one embodiment of the present invention will be described with reference to FIG. 4A to FIG. 7D.

### Coin-Type Secondary Battery

As an example of the shape of the secondary battery of one embodiment of the present invention, a coin-type secondary battery will be described first. FIG. 4A is an external view of a coin-type (single-layer flat type) secondary battery, and FIG. 4B is a cross-sectional view thereof.

In a coin-type secondary battery 300, a positive electrode can 301 doubling as a positive electrode terminal and a negative electrode can 302 doubling as a negative electrode terminal are insulated from each other and sealed by a gasket 303 made of polypropylene or the like. A positive electrode 304 includes a positive electrode current collector 305 and a positive electrode active material layer 306 provided in contact with the positive electrode current collector 305. A negative electrode 307 includes a negative electrode current collector 308 and a negative electrode active material layer 309 provided in contact with the negative electrode current collector 308.

Note that in the positive electrode 304 and the negative electrode 307 used for the coin-type secondary battery 300, only one surface of the current collector is provided with the respective active material layer.

For the positive electrode can 301 and the negative electrode can 302, a metal having corrosion resistance to an electrolyte solution, such as nickel, aluminum, or titanium, an alloy of such a metal, and an alloy of such a metal and another metal (e.g., stainless steel) can be used. Alternatively, the positive electrode can 301 and the negative electrode can 302 are preferably coated with nickel, aluminum, or the like in order to prevent corrosion due to the electrolyte solution. The positive electrode can 301 and the negative electrode can 302 are electrically connected to the positive electrode 304 and the negative electrode 307, respectively.

The coin-type secondary battery 300 is manufactured in the following manner: as illustrated in FIG. 4B, the positive electrode 304, an electrolyte layer 310, the negative electrode 307, and the negative electrode can 302 are stacked in this sequence with the positive electrode can 301 positioned at the bottom; and then the positive electrode can 301 and the negative electrode can 302 are subjected to pressure bonding with the gasket 303 therebetween.

When the positive electrode active material described in the above embodiment is used in the positive electrode 304, the coin-type secondary battery 300 with high charge and discharge capacity and excellent cycle performance can be obtained.

Here, a current flow in charging a secondary battery is described with reference to FIG. 4C. When a secondary battery using lithium is regarded as a closed circuit, movement of lithium ions and the current flow are in the same direction. Note that in a secondary battery using lithium, the anode and the cathode are interchanged in charging and discharging, and the oxidation reaction and the reduction reaction are interchanged; thus, an electrode with a high reaction potential is called the positive electrode and an electrode with a low reaction potential is called the negative electrode. For this reason, in this specification, the positive electrode is referred to as a “positive electrode” or a “plus electrode” and the negative electrode is referred to as a “negative electrode” or a “minus electrode” in all the cases where charge is performed, discharge is performed, a reverse pulse current is supplied, and a charge current is supplied. The use of terms such as anode and cathode related to oxidation reaction and reduction reaction might cause confusion because the anode and the cathode are reversed in charging and in discharging. Thus, the terms “anode” and “cathode” are not used in this specification. If the term anode or cathode is used, whether it is at the time of charging or discharging is noted and whether it corresponds to a positive electrode or a negative electrode is also noted.

Two terminals illustrated in FIG. 4C are connected to a charger, and the secondary battery 300 is charged. As the charge of the secondary battery 300 proceeds, a potential difference between electrodes increases.

### Stack-Type Secondary Battery

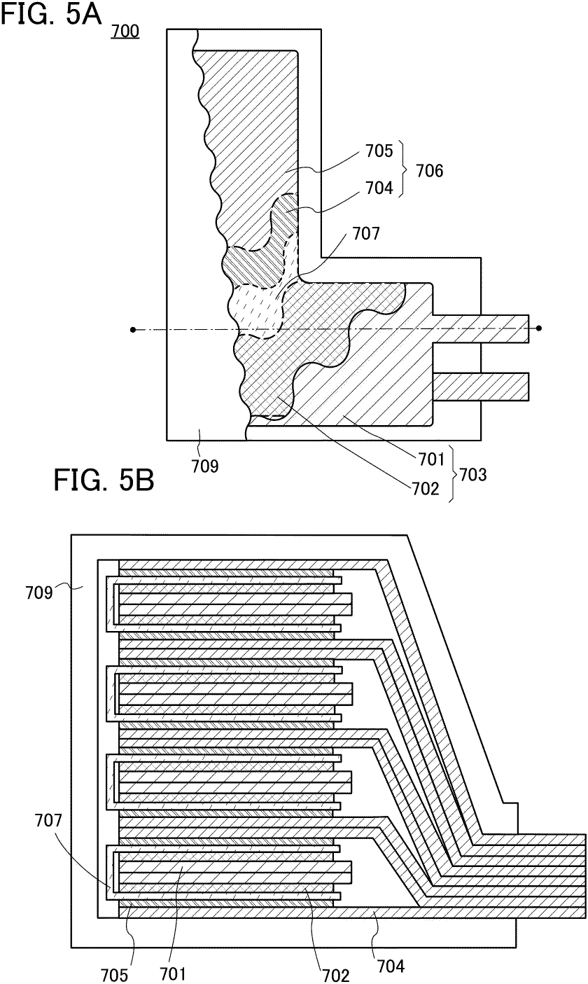

The secondary battery of one embodiment of the present invention may be a secondary battery 700 in which a plurality of electrodes are stacked as illustrated in FIG. 5A and FIG. 5B. The electrode and the exterior body may have an L-shape, without being limited to a rectangular shape.

The laminated secondary battery 700 illustrated in FIG. 5A includes a positive electrode 703 including a positive electrode current collector 701 and a positive electrode active material layer 702 that have an L-shape, a negative electrode 706 including a negative electrode current collector 704 and a negative electrode active material layer 705 that have an L-shape, an electrolyte layer 707, and an exterior body 709. The electrolyte layer 707 is placed between the positive electrode 703 and the negative electrode 706 provided in the exterior body 709.

In the laminated secondary battery 700 illustrated in FIG. 5A, the positive electrode current collector 701 and the negative electrode current collector 704 also serve as terminals for electrical contact with the outside. For this reason, portions of the positive electrode current collector 701 and the negative electrode current collector 704 may be placed to be exposed to the outside of the exterior body 709. Alternatively, a lead electrode and the positive electrode current collector 701 or the negative electrode current collector 704 may be bonded to each other by ultrasonic welding, and instead of the positive electrode current collector 701 and the negative electrode current collector 704, the lead electrode may be exposed to the outside of the exterior body 709.

As the exterior body 709 of the laminated secondary battery, for example, a laminate film having a three-layer structure can be used in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

FIG. 5B illustrates an example of a cross-sectional structure of the laminated secondary battery. Although FIG. 5A selectively illustrates a pair of electrodes and a single electrolyte layer for simplicity, it is more preferable in a practical case if a plurality of electrodes and a plurality of electrolyte layers are included as illustrated in FIG. 5B.

In FIG. 5B, the number of electrodes is 16, for example. FIG. 5B illustrates a structure including eight layers of negative electrode current collectors 704 and eight layers of positive electrode current collectors 701, i.e., 16 layers in total. Note that FIG. 5B illustrates a cross section of a lead portion of the positive electrode, which is cut along the chain line in FIG. 5A, and the eight layers of negative electrode current collectors 704 are bonded to each other by ultrasonic welding. It is needless to say that the number of electrode layers is not limited to 16, and may be more than 16 or less than 16. In the case where the number of electrode layers is large, the secondary battery can have higher capacity. In the case where the number of electrode layers is small, the secondary battery can be thinner.

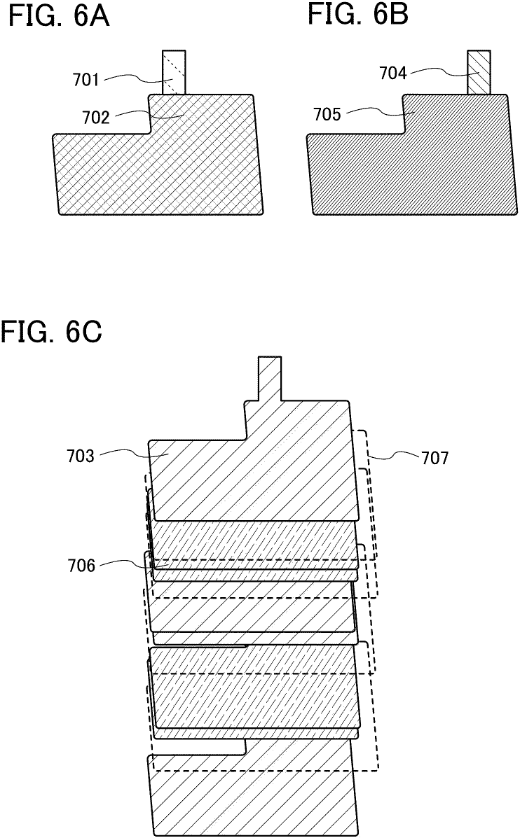

FIG. 6A illustrates a positive electrode including the L-shaped positive electrode current collector 701 and positive electrode active material layer 702 in the secondary battery 700. The positive electrode includes a region where the positive electrode current collector 701 is partly exposed (hereinafter, referred to as a tab region). In addition, FIG. 6B illustrates a negative electrode including the L-shaped negative electrode current collector 704 and negative electrode active material layer 705 in the secondary battery 700. The negative electrode includes a region where the negative electrode current collector 704 is partly exposed, that is, a tab region.

FIG. 6C illustrates a perspective view in which four layers of positive electrodes 703 and four layers of negative electrodes 706 are stacked. Note that in FIG. 6C, the electrolyte layers 707 provided between the positive electrodes 703 and the negative electrodes 706 are indicated by dotted lines for simplicity.

### Winding Type Secondary Battery

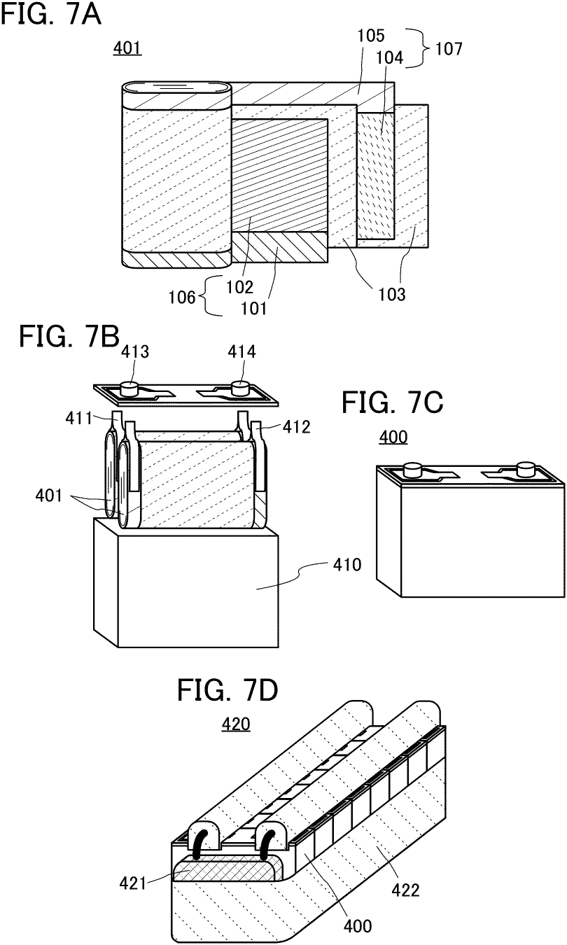

The secondary battery of one embodiment of the present invention may be a secondary battery 400 including a wound body 401 in an exterior body 410, as illustrated in FIG. 7A to FIG. 7C. The wound body 401 illustrated in FIG. 7A includes the negative electrode 107, the positive electrode 106, and the electrolyte layer 103. The negative electrode 107 includes the negative electrode active material layer 104 and the negative electrode current collector 105. The positive electrode 106 includes the positive electrode active material layer 102 and the positive electrode current collector 101. The electrolyte layer 103 has a width greater than those of the negative electrode active material layer 104 and the positive electrode active material layer 102, and is wound in such a manner as to overlap with the negative electrode active material layer 104 and the positive electrode active material layer 102. The electrolyte layer 103 can be wound in this way because the electrolyte layer 103 including a lithium-ion conductive polymer and a lithium salt is flexible. Note that, in terms of safety, the width of the negative electrode active material layer 104 is preferably greater than that of the positive electrode active material layer 102. The wound body 401 having such a shape is preferable because of its high degree of safety and high productivity.

As illustrated in FIG. 7B, the negative electrode 107 is electrically connected to a terminal 411. The terminal 411 is electrically connected to a terminal 413. The positive electrode 106 is electrically connected to a terminal 412. The terminal 412 is electrically connected to a terminal 414.

As illustrated in FIG. 7B, the secondary battery 400 may include a plurality of wound bodies 401. The use of the plurality of wound bodies 401 enables the secondary battery 400 to have higher charge and discharge capacity.

The secondary battery 400 can have high charge and discharge capacity and excellent cycle performance, with the use of the positive electrode 106, the electrolyte layer 103, and the negative electrode 107, which are described in the above embodiment, as the positive electrode 106, the electrolyte layer 103, and the negative electrode 107, respectively.

As illustrated in FIG. 7D, a module 420 including a plurality of secondary batteries 400 may be fabricated. The module 420 preferably includes a battery controller 421. The battery controller 421 has a function of monitoring the conditions of secondary batteries (e.g., charging and discharge amounts and temperature) and preventing overcharge, overdischarge, and overheat. It is preferable that the plurality of secondary batteries 400 be protected and fixed to one another with a protector 422.

This embodiment can be used in combination with the other embodiments.

### Embodiment 4

In this embodiment, examples of providing vehicles, buildings, moving objects, electronic devices, and the like with the secondary battery of one embodiment of the present invention will be described.

Examples of electronic devices each including a secondary battery include television devices (also referred to as televisions or television receivers), monitors of computers or the like, digital cameras, digital video cameras, digital photo frames, cellular phones (also referred to as mobile phones or mobile phone devices), portable game machines, portable information terminals, audio reproducing devices, and large game machines such as pachinko machines.

The secondary battery can also be used in moving vehicles, typically automobiles. Examples of the automobiles include next-generation clean energy vehicles such as hybrid vehicles (HVs), electric vehicles (EVs), and plug-in hybrid vehicles (also referred to as PHEVs or PHVs), and the secondary battery can be used as one of the power sources provided for the automobiles. The moving vehicle is not limited to an automobile. Examples of the moving vehicles include a train, a monorail train, a ship, and a flying object (a helicopter, an unmanned aircraft (a drone), an airplane, and a rocket), an electric bicycle, and an electric motorcycle, and these moving vehicles can use a secondary battery of one embodiment of the present invention.

The secondary battery of this embodiment may be used in a ground-based charging apparatus provided for a house or a charging station provided in a commerce facility.

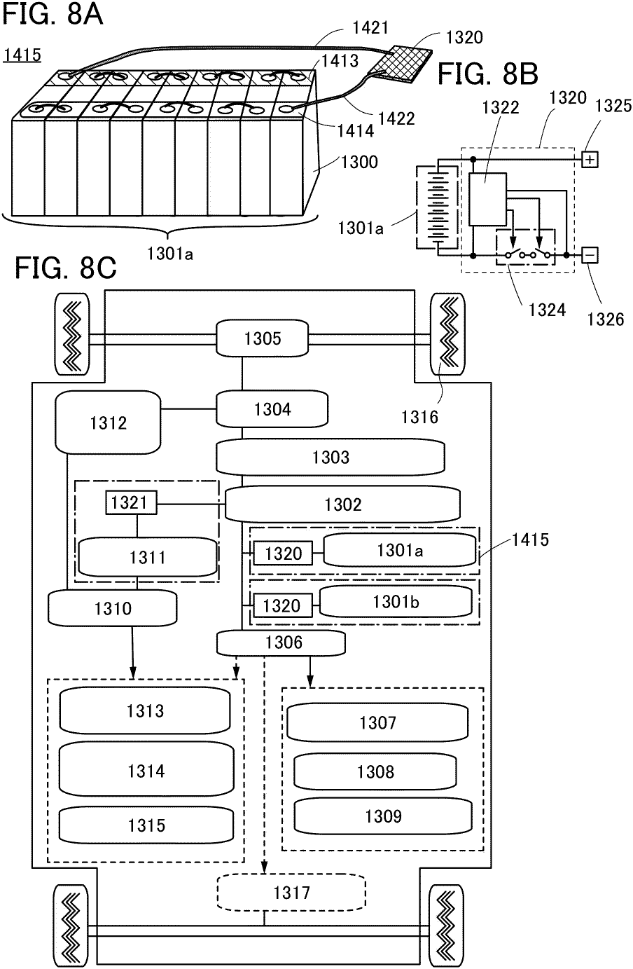

First, FIG. 8C illustrates an example in which the secondary battery described in part of Embodiment 3 is used in an electric vehicle (EV).

The electric vehicle is provided with first batteries 1301a and 1301b as main secondary batteries for driving and a second battery 1311 that supplies electric power to an inverter 1312 for starting a motor 1304. The second battery 1311 is also referred to as a cranking battery or a starter battery. The second battery 1311 specifically needs high output and does not necessarily require high capacity, and the capacity of the second battery 1311 is lower than that of the first battery 1301a or 1301b.

The internal structure of the first battery 1301a may be a laminated type as illustrated in FIG. 5A or a wound type as illustrated in FIG. 7A.

Although this embodiment describes an example in which two first batteries 1301a and 1301b are connected in parallel, three or more first batteries may be connected in parallel. When the first battery 1301a is capable of storing sufficient electric power, the first battery 1301b may be omitted. With a battery pack including a plurality of secondary batteries, large electric power can be extracted. The plurality of secondary batteries may be connected in parallel, connected in series, or connected in series after being connected in parallel. The plurality of secondary batteries can also be referred to as an assembled battery.

An in-vehicle secondary battery includes a service plug or a circuit breaker that can cut off high voltage without the use of equipment in order to cut off electric power from a plurality of secondary batteries. The first battery 1301a is provided with such a service plug or a circuit breaker.

Electric power from the first batteries 1301a and 1301b is mainly used to rotate the motor 1304 and is also supplied to in-vehicle parts for 42 V (such as an electric power steering 1307, a heater 1308, and a defogger 1309) through a DC-DC circuit 1306. In the case where there is a rear motor 1317 for the rear wheels, the first battery 1301a is used to rotate the rear motor 1317.

The second battery 1311 supplies electric power to in-vehicle parts for 14 V (such as an audio 1313, power windows 1314, and lamps 1315) through a DC-DC circuit 1310.

The first battery 1301a will be described with reference to FIG. 8A.

FIG. 8A illustrates an example in which nine rectangular secondary batteries 1300 form one battery pack 1415. The nine rectangular secondary batteries 1300 are connected in series; one electrode of each battery is fixed by a fixing portion 1413 made of an insulator, and the other electrode of each battery is fixed by a fixing portion 1414 made of an insulator. Although this embodiment shows the example in which the secondary batteries are fixed by the fixing portions 1413 and 1414, they may be stored in a battery container box (also referred to as a housing). Since a vibration or a jolt is assumed to be given to the vehicle from the outside (e.g., a road surface), the plurality of secondary batteries are preferably fixed by the fixing portions 1413 and 1414 and/or a battery container box, for example. Furthermore, the one electrode of each battery is electrically connected to a control circuit portion 1320 through a wiring 1421. The other electrode of each battery is electrically connected to the control circuit portion 1320 through a wiring 1422.

The control circuit portion 1320 may include a memory circuit including a transistor using an oxide semiconductor. A charge control circuit or a battery control system that includes a memory circuit including a transistor using an oxide semiconductor may be referred to as a battery operating system or a battery oxide semiconductor (BTOS).

A metal oxide functioning as an oxide semiconductor is preferably used. For example, as the metal oxide, a metal oxide such as an In—M—Zn oxide (the elementMis one or more selected from aluminum, gallium, yttrium, copper, vanadium, beryllium, boron, titanium, iron, nickel, germanium, zirconium, molybdenum, lanthanum, cerium, neodymium, hafnium, tantalum, tungsten, magnesium, and the like) is preferably used. In particular, the In—M—Zn oxide that can be used as the metal oxide is preferably a c-axis aligned crystal oxide semiconductor (CAAC-OS) or a cloud-aligned composite oxide semiconductor (CAC-OS). Alternatively, an In—Ga oxide or an In—Zn oxide may be used as the metal oxide. The CAAC-OS is an oxide semiconductor that has a plurality of crystal regions each of which has c-axis alignment in a particular direction. Note that the particular direction refers to the thickness direction of a CAAC-OS film, the normal direction of the surface where the CAAC-OS film is formed, or the normal direction of the surface of the CAAC-OS film. The crystal region refers to a region having a periodic atomic arrangement. When an atomic arrangement is regarded as a lattice arrangement, the crystal region also refers to a region with a uniform lattice arrangement. The CAAC-OS has a region where a plurality of crystal regions are connected in the a-b plane direction, and the region has distortion in some cases. Note that distortion refers to a portion where the direction of a lattice arrangement changes between a region with a uniform lattice arrangement and another region with a uniform lattice arrangement in a region where a plurality of crystal regions are connected. That is, the CAAC-OS is an oxide semiconductor having c-axis alignment and having no clear alignment in the a-b plane direction. In addition, the CAC-OS has, for example, a composition in which elements included in a metal oxide are unevenly distributed. Materials including unevenly distributed elements each have a size greater than or equal to 0.5 nm and less than or equal to 10 nm, preferably greater than or equal to 1 nm and less than or equal to 3 nm, or a similar size. Note that in the following description of a metal oxide, a state in which one or more types of metal elements are unevenly distributed and regions including the metal element(s) are mixed is referred to as a mosaic pattern or a patch-like pattern. The regions each have a size greater than or equal to 0.5 nm and less than or equal to 10 nm, preferably greater than or equal to 1 nm and less than or equal to 3 nm, or a similar size.

In addition, the CAC-OS has a composition in which materials are separated into a first region and a second region to form a mosaic pattern, and the first regions are distributed in the film. This composition is hereinafter also referred to as a cloud-like composition. That is, the CAC-OS is a composite metal oxide having a composition in which the first regions and the second regions are mixed.

Here, the atomic ratios of In, Ga, and Zn to the metal elements contained in the CAC—OS in an In—Ga—Zn oxide are denoted by [In], [Ga], and [Zn], respectively. For example, the first region in the CAC-OS in the In—Ga—Zn oxide has [In] higher than that in the composition of the CAC-OS film. Moreover, the second region of the CAC-OS in the In—Ga—Zn oxide has [Ga] higher than that in the composition of the CAC-OS film. Alternatively, for example, the first region has higher [In] and lower [Ga] than the second region. Moreover, the second region has higher [Ga] and lower [In] than the first region.

Specifically, the first region includes indium oxide, indium zinc oxide, or the like as its main component. The second region includes gallium oxide, gallium zinc oxide, or the like as its main component. That is, the first region can be referred to as a region containing In as its main component. The second region can be referred to as a region containing Ga as its main component.

Note that a clear boundary between the first region and the second region cannot be observed in some cases.

For example, according to EDX mapping obtained by EDX, the CAC-OS in the In—Ga—Zn oxide has a composition in which the region containing In as its main component (the first region) and the region containing Ga as its main component (the second region) are unevenly distributed and mixed.

In the case where the CAC-OS is used for a transistor, a switching function (on/off switching function) can be given to the CAC-OS owing to the complementary action of the conductivity derived from the first region and the insulating property derived from the second region. That is, the CAC-OS has a conducting function in part of the material and has an insulating function in another part of the material; as a whole, the CAC-OS has a function of a semiconductor. Separation of the conducting function and the insulating function can maximize each function. Thus, when the CAC-OS is used for a transistor, high on-state current (Iₒₙ), high field-effect mobility (µ), and favorable switching operation can be achieved.

An oxide semiconductor can have any of various structures that show various different properties. Two or more of an amorphous oxide semiconductor, a polycrystalline oxide semiconductor, an a-like OS, the CAC-OS, an nc-OS, and the CAAC-OS may be included in an oxide semiconductor of one embodiment of the present invention.

The control circuit portion 1320 preferably uses a transistor using an oxide semiconductor because the transistor using an oxide semiconductor can be used in a high-temperature environment. For the process simplicity, the control circuit portion 1320 may be formed using transistors of the same conductivity type. A transistor using an oxide semiconductor in its semiconductor layer has an operating ambient temperature range of -40° C. to 150° C., which is wider than that of a single crystal Si transistor, and thus shows a smaller change in characteristics than the single crystal Si transistor when the secondary battery is heated. The off-state current of the transistor using an oxide semiconductor is lower than or equal to the lower measurement limit even at 150° C. regardless of the temperature. On the other hand, the off-state current of the single crystal Si transistor largely depends on the temperature. For example, at 150° C., the off-state current of the single crystal Si transistor increases, and a sufficiently high current on/off ratio cannot be obtained. The control circuit portion 1320 can contribute to elimination of accidents due to secondary batteries, such as fires.

The control circuit portion 1320 that uses a memory circuit including a transistor using an oxide semiconductor can also function as an automatic control device for the secondary battery to resolve ten items of causes of instability, such as a micro-short circuit. Examples of functions of resolving the ten items of causes of instability include prevention of overcharging, prevention of overcurrent, control of overheating during charging, maintenance of cell balance of an assembled battery, prevention of overdischarging, a battery indicator, automatic control of charge voltage and current amount according to temperature, control of the amount of charge current according to the degree of deterioration, abnormal behavior detection for a micro-short circuit, and anomaly prediction regarding a micro-short circuit. The control circuit portion 1320 has at least one of these functions. Furthermore, the automatic control device for the secondary battery can be extremely small in size.

A micro-short circuit refers to a minute short circuit caused in a secondary battery. A micro-short circuit refers to not a state where the positive electrode and the negative electrode of a secondary battery are short-circuited so that charging and discharging are impossible, but a phenomenon in which a slight short-circuit current flows through a minute short-circuit portion. Since a large voltage change is caused even when a micro-short circuit occurs in a relatively short time in a minute area, the abnormal voltage value might adversely affect anomaly prediction to be performed subsequently.

One of the supposed causes of a micro-short circuit is as follows. Uneven distribution of a positive electrode active material due to charging and discharging performed multiple times causes local current concentration at part of the positive electrode and part of the negative electrode; thus, insulation between the positive electrode and the negative electrode is partly broken. Another supposed cause is generation of a by-product due to a side reaction.

It can be said that the control circuit portion 1320 not only detects a micro-short circuit but also senses a terminal voltage of the secondary battery and controls the charge and discharge state of the secondary battery. For example, to prevent overcharging, the control circuit portion 1320 can turn off an output transistor of a charging circuit and an interruption switch substantially at the same time.

FIG. 8B is an example of a block diagram of the battery pack 1415 illustrated in FIG. 8A.

The control circuit portion 1320 includes a switch portion 1324 that includes at least a switch for preventing overcharging and a switch for preventing overdischarging, a control circuit 1322 for controlling the switch portion 1324, and a portion for measuring the voltage of the first battery 1301a. The control circuit portion 1320 is set to have the upper limit voltage and the lower limit voltage of the secondary battery used, and controls the upper limit of current from the outside, the upper limit of output current to the outside, or the like. The range from the lower limit voltage to the upper limit voltage of the secondary battery is a recommended voltage range, and when a voltage is out of the range, the switch portion 1324 operates and functions as a protection circuit. The control circuit portion 1320 can also be referred to as a protection circuit because it controls the switch portion 1324 to prevent overdischarging and overcharging. For example, when the control circuit 1322 detects a voltage that is likely to cause overcharging, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (-IN).

The switch portion 1324 can be formed by a combination of an n-channel transistor and a p-channel transistor. The switch portion 1324 is not limited to including a switch having a Si transistor using single crystal silicon; the switch portion 1324 may be formed using a power transistor containing germanium (Ge), silicon germanium (SiGe), gallium arsenide (GaAs), gallium aluminum arsenide (GaAlAs), indium phosphide (InP), silicon carbide (SiC), zinc selenide (ZnSe), gallium nitride (GaN), gallium oxide (GaOₓ, where x is a real number greater than 0), or the like. A memory element using an OS transistor can be freely placed by being stacked over a circuit using a Si transistor, for example; hence, integration can be easy. Furthermore, an OS transistor can be manufactured with a manufacturing apparatus similar to that for a Si transistor and thus can be manufactured at low cost. That is, the control circuit portion 1320 using OS transistors can be stacked over the switch portion 1324 so that they can be integrated into one chip. Since the area occupied by the control circuit portion 1320 can be reduced, a reduction in size is possible.

The first batteries 1301a and 1301b mainly supply electric power to in-vehicle parts for 42 V (for a high-voltage system), and the second battery 1311 supplies electric power to in-vehicle parts for 14 V (for a low-voltage system). Lead batteries are usually used for the second battery 1311 due to cost advantage.

In this embodiment, an example in which a lithium-ion secondary battery is used as each of the first battery 1301a and the second battery 1311 is described. As the second battery 1311, a lead storage battery, an inorganic all-solid-state battery, and/or an electric double layer capacitor may alternatively be used.

Regenerative energy generated by rolling of tires 1316 is transmitted to the motor 1304 through a gear 1305, and is stored in the second battery 1311 through a motor controller 1303, a battery controller 1302, and a control circuit portion 1321. Alternatively, the regenerative energy is stored in the first battery 1301a through the battery controller 1302 and the control circuit portion 1320. Alternatively, the regenerative energy is stored in the first battery 1301b through the battery controller 1302 and the control circuit portion 1320. For efficient charging with regenerative energy, the first batteries 1301a and 1301b are preferably capable of fast charging.

The battery controller 1302 can set the charge voltage, charge current, and the like of the first batteries 1301a and 1301b. The battery controller 1302 can set charge conditions in accordance with charge characteristics of a secondary battery used, so that fast charging can be performed.

Although not illustrated, when the electric vehicle is connected to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharging, the first batteries 1301a and 1301b are preferably charged through the control circuit portion 1320. In addition, a connection cable or a connection cable of the charger is sometimes provided with a control circuit. The control circuit portion 1320 is also referred to as an electronic control unit (ECU). The ECU is connected to a controller area network (CAN) provided in the electric vehicle. The CAN is a type of a serial communication standard used as an in-vehicle LAN. The ECU includes a microcomputer. Moreover, the ECU uses a CPU or a GPU.

External chargers installed at charging stations and the like have a 100 V outlet, a 200 V outlet, or a three-phase 200 V outlet with 50 kW, for example. Furthermore, charging can be performed with electric power supplied from external charging equipment by a contactless power feeding system or the like.

For fast charging, secondary batteries that can withstand high-voltage charging have been desired to perform charging in a short time.

The above secondary battery described in this embodiment includes a lithium-ion conductive polymer in the electrolyte. Thus, the level of safety of the secondary battery can improve. Thus, a vehicle using the secondary battery can have a higher level of safety.

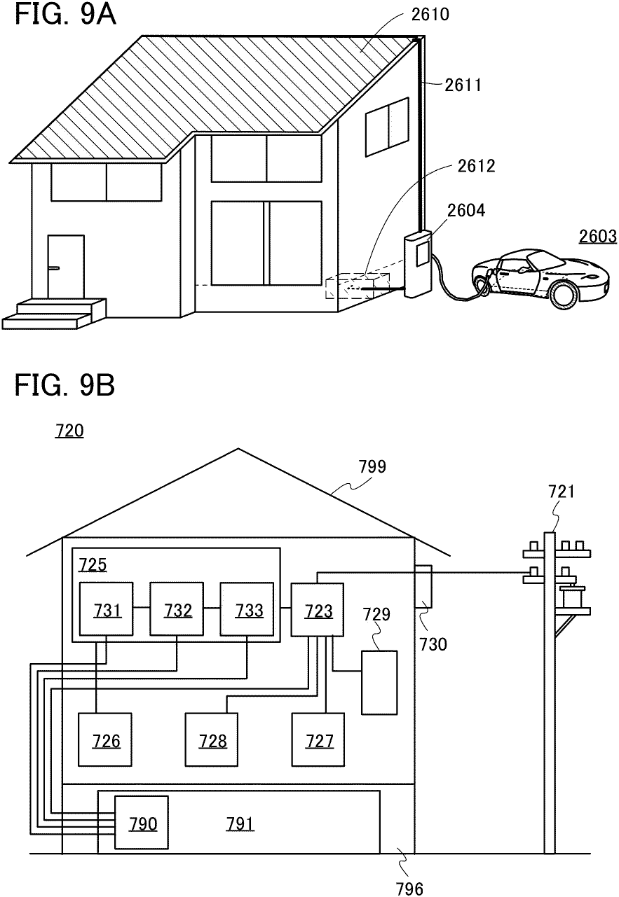

Next, examples in which a building is provided with the secondary battery of one embodiment of the present invention will be described with reference to FIG. 9A and FIG. 9B.

The house illustrated in FIG. 9A includes a power storage device 2612 including the secondary battery of one embodiment of the present invention and a solar panel 2610. The power storage device 2612 is electrically connected to the solar panel 2610 through a wiring 2611 or the like. The power storage device 2612 may be electrically connected to a ground-based charging device 2604. The power storage device 2612 can be charged with electric power generated by the solar panel 2610. The secondary battery included in a vehicle 2603 can be charged with the electric power stored in the power storage device 2612 through the charging device 2604. The power storage device 2612 is preferably provided in the underfloor space, in which case the space on the floor can be effectively used. Alternatively, the power storage device 2612 may be provided on the floor.

The electric power stored in the power storage device 2612 can also be supplied to other electronic devices in the house. Thus, with the use of the power storage device 2612 of one embodiment of the present invention as an uninterruptible power source, electronic devices can be used even when electric power cannot be supplied from a commercial power source due to power failure or the like.

FIG. 9B illustrates an example of a power supply system 720 of one embodiment of the present invention. As illustrated in FIG. 9B, a power storage device 791 of one embodiment of the present invention is provided in an underfloor space 796 of a building 799.

The power storage device 791 is provided with a control device 790, and the control device 790 is electrically connected to a distribution board 723, a power storage controller 725 (also referred to as control device), an indicator 726, and a router 729 through wirings.

Electric power is transmitted from a commercial power source 721 to the distribution board 723 through a service wire mounting portion 730. Moreover, electric power is transmitted to the distribution board 723 from the power storage device 791 and the commercial power source 721, and the distribution board 723 supplies the transmitted electric power to a general load 727 and a power storage load 728 through outlets (not illustrated).

The general load 727 is, for example, an electrical device such as a TV or a personal computer. The power storage load 728 is, for example, an electrical device such as a microwave, a refrigerator, or an air conditioner.

The power storage controller 725 includes a measuring portion 731, a predicting portion 732, and a planning portion 733. The measuring portion 731 has a function of measuring the amount of electric power consumed by the general load 727 and the power storage load 728 during a day (for 24 hours from 12 o′clock at night, for example). The measuring portion 731 may also have a function of measuring the amount of electric power of the power storage device 791 and the amount of electric power supplied from the commercial power source 721. The predicting portion 732 has a function of predicting, on the basis of the amount of electric power consumed by the general load 727 and the power storage load 728 during a given day, the demand for electric power consumed by the general load 727 and the power storage load 728 during the next day. The planning portion 733 has a function of making a charge and discharge plan of the power storage device 791 on the basis of the demand for electric power predicted by the predicting portion 732.

An indicator 726 can show the amount of electric power consumed by the general load 727 and the power storage load 728 that is measured by the measuring portion 731. An electrical device such as a TV or a personal computer can also show it through the router 729. Furthermore, a portable electronic terminal such as a smartphone or a tablet can also show it through the router 729. The indicator 726, the electrical device, and the portable electronic terminal can also show, for example, the demand for electric power depending on a time period (or per hour) that is predicted by the predicting portion 732.

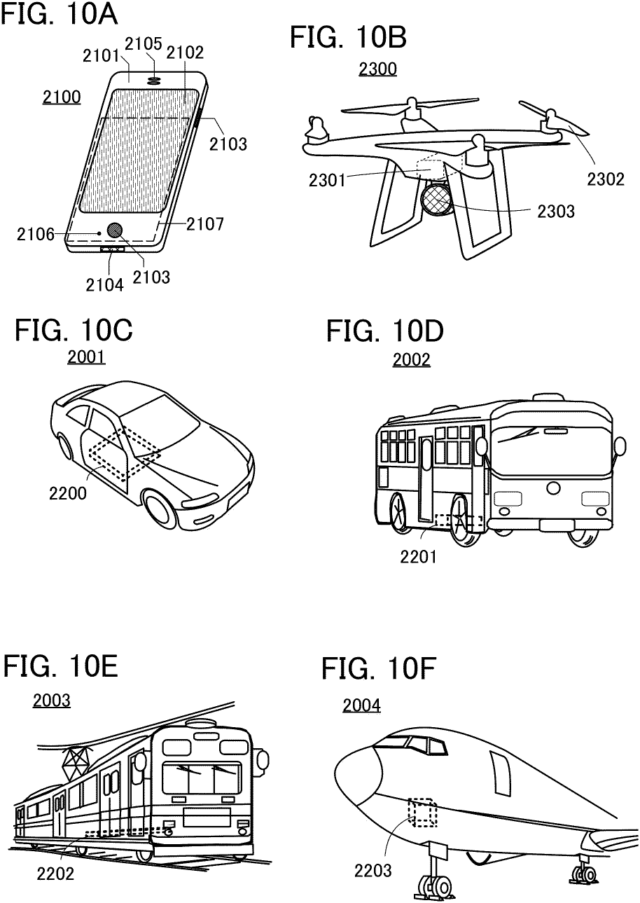

Next, examples of providing electronic devices with the secondary battery of one embodiment of the present invention are illustrated in FIG. 10A and FIG. 10B. FIG. 10A illustrates an example of a mobile phone. A mobile phone 2100 includes a display portion 2102 installed in a housing 2101, an operation button 2103, an external connection port 2104, a speaker 2105, a microphone 2106, and the like. Note that the mobile phone 2100 includes a secondary battery 2107.

The mobile phone 2100 is capable of executing a variety of applications such as mobile phone calls, e-mailing, viewing and editing texts, music reproduction, Internet communication, and computer games.

With the operation button 2103, a variety of functions such as time setting, power on/off operation, wireless communication on/off operation, execution and cancellation of a silent mode, and execution and cancellation of a power saving mode can be performed. For example, the functions of the operation button 2103 can also be set freely by an operating system incorporated in the mobile phone 2100.

In addition, the mobile phone 2100 can execute near field communication conformable to a communication standard. For example, by mutual communication between the mobile phone 2100 and a headset capable of wireless communication, hands-free calling can be performed.

Moreover, the mobile phone 2100 includes the external connection port 2104, and data can be directly transmitted to and received from another information terminal via a connector. In addition, charging can be performed via the external connection port 2104. Note that the charging operation may be performed by wireless power feeding without using the external connection port 2104.

The mobile phone 2100 preferably includes a sensor. As the sensor, for example, a human body sensor such as a fingerprint sensor, a pulse sensor, or a temperature sensor, a touch sensor, a pressure sensitive sensor, or an acceleration sensor is preferably included.

FIG. 10B illustrates an unmanned aircraft 2300 including a plurality of rotors 2302. The unmanned aircraft 2300 is also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. The secondary battery of one embodiment of the present invention is preferable as a secondary battery mounted on the unmanned aircraft 2300 because it has a high level of safety and thus can be used safely for long hours over an extended period of time.

Next, examples of a transport vehicle using one embodiment of the present invention are illustrated in FIG. 10C to FIG. 10F. An automobile 2001 illustrated in FIG. 10C is an electric vehicle that runs on an electric motor as a power source. Alternatively, the automobile 2001 is a hybrid electric vehicle that can appropriately select an electric motor or an engine as a driving power source. In the case where the secondary battery is mounted on the vehicle, an example of the secondary battery described in Embodiment 3 is provided at one position or several positions. The automobile 2001 illustrated in FIG. 10C includes a battery pack 2200, and the battery pack includes a secondary battery module in which a plurality of secondary batteries are connected to each other. Moreover, the battery pack preferably includes a charge control device that is electrically connected to the secondary battery module.

The automobile 2001 can be charged when the secondary battery of the automobile 2001 receives electric power from an external charging equipment through a plug-in system, a contactless charging system, and the like. In charging, a given method such as CHAdeMO (registered trademark) and Combined Charging System may be employed as a charging method, the standard of a connector, and the like as appropriate. The charging device may be a charging station provided in a commerce facility or a household power supply. For example, a plug-in technique enables an exterior power supply to charge the secondary battery incorporated in the automobile 2001. Charging can be performed by converting AC power into DC power through a converter such as an ACDC converter.

Although not illustrated, the vehicle can include a power receiving device so as to be charged by being supplied with power from an above-ground power transmitting device in a contactless manner. For the contactless power feeding system, by fitting a power transmitting device in a road and/or an exterior wall, charging can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops and/or moves. To supply power in such a contactless manner, an electromagnetic induction method and/or a magnetic resonance method can be used.

FIG. 10D shows a large transporter 2002 having a motor controlled by electric power, as an example of a transport vehicle. The secondary battery module of the transporter 2002 has a cell unit of four secondary batteries with 3.5 V or more and 4.7 V or lower, and 48 cells are connected in series to have 170 V as the maximum voltage. A battery pack 2201 has the same function as that in FIG. 10C except that the number of secondary batteries forming the secondary battery module of the battery pack 2201 or the like is different; thus the description is omitted.

FIG. 10E shows a large transportation vehicle 2003 having a motor controlled by electricity as an example. The secondary battery module of the transportation vehicle 2003 has more than 100 secondary batteries with 3.5 V or more and 4.7 V or lower connected in series, and the maximum voltage is 600 V, for example. Thus, the secondary batteries are required to have few variations in the characteristics. The secondary battery of one embodiment of the present invention has a high level of safety and its volume production at low costs is possible in light of the yield; thus, the secondary battery of one embodiment of the present invention is suitable for the secondary battery modules of the transportation vehicle 2003. A battery pack 2202 has the same function as that in FIG. 10C except that the number of secondary batteries forming the secondary battery module of the battery pack 2202 or the like is different; thus the detailed description is omitted.

FIG. 10F shows an aircraft 2004 having a combustion engine as an example. The aircraft 2004 shown in FIG. 10F can be regarded as a portion of a transportation vehicle since it is provided with wheels for takeoff and landing, and has a battery pack 2203 including a secondary battery module and a charging control device; the secondary battery module includes a plurality of connected secondary batteries.

The secondary battery module of the aircraft 2004 has eight 4 V secondary batteries connected in series, which has the maximum voltage of 32 V, for example. A battery pack 2203 has the same function as that in FIG. 10C except that the number of secondary batteries forming the secondary battery module of the battery pack 2203 or the like is different; thus the detailed description is omitted. In this embodiment, examples in which a motorcycle or a bicycle is provided with a power storage device of one embodiment of the present invention will be described.

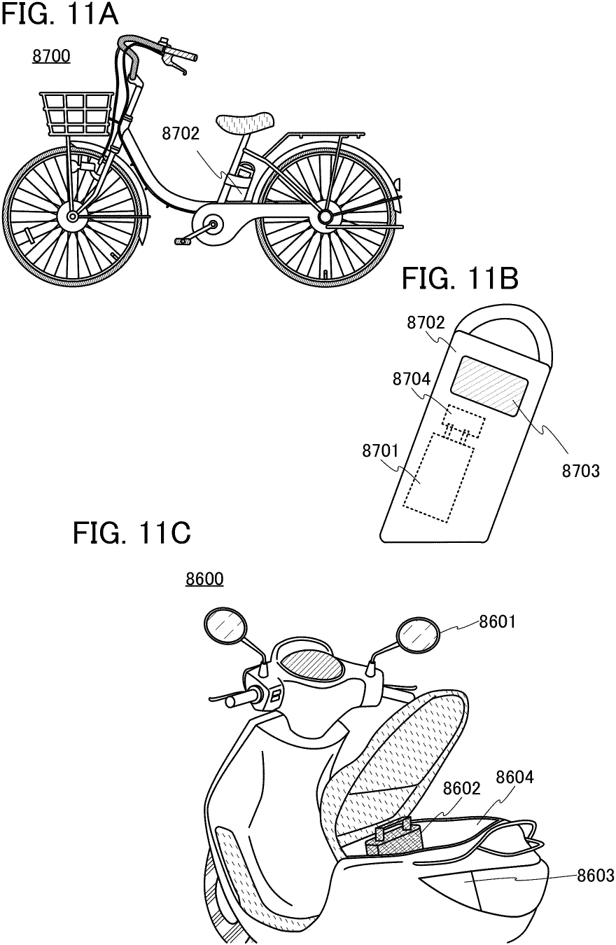

Next, an example of an electric bicycle in which the secondary battery of one embodiment of the present invention is used is illustrated in FIG. 11A. The power storage device of one embodiment of the present invention can be used for an electric bicycle 8700 illustrated in FIG. 11A. The power storage device of one embodiment of the present invention includes a plurality of storage batteries and a protection circuit, for example.

The electric bicycle 8700 includes a power storage device 8702. The power storage device 8702 can supply electricity to a motor that assists a rider. The power storage device 8702 is portable, and FIG. 11B illustrates the state where the power storage device 8702 is detached from the bicycle. A plurality of storage batteries 8701 included in the power storage device of one embodiment of the present invention are incorporated in the power storage device 8702, and the remaining battery capacity and the like can be displayed on a display portion 8703. The power storage system 8702 also includes a control circuit 8704 of one embodiment of the present invention. The control circuit 8704 is electrically connected to a positive electrode and a negative electrode of the storage battery 8701.

Next, FIG. 11C illustrates an example of a motorcycle in which the secondary battery of one embodiment of the present invention is used. A motor scooter 8600 illustrated in FIG. 11C includes a power storage device 8602, side mirrors 8601, and indicator lights 8603. The power storage device 8602 can supply electricity to the indicator lights 8603.

In the motor scooter 8600 illustrated in FIG. 11C, the power storage device 8602 can be stored in a storage unit under seat 8604. The power storage device 8602 can be stored in the storage unit under seat 8604 even with a small size.

This embodiment can be implemented in appropriate combination with any of the other embodiments.

### Example 1

In this example, a secondary battery with a positive electrode active material layer including a lithium-ion conductive polymer and a lithium salt, which is one embodiment of the present invention, was fabricated and its characteristics were evaluated.

### Fabrication of Secondary Battery

First, a positive electrode was fabricated in the following manner. As a positive electrode active material, lithium cobalt oxide (LCO) was used. As a conductive material, acetylene black (AB) was used. As a lithium-ion conductive polymer, polyethylene oxide (PEO, with a molecular weight of approximately 600,000, produced by ALDRICH) was used. As a lithium salt, lithium bis(fluorosulfonyl)imide (LiFSI, produced by Kishida Chemical Co., Ltd.) was used. Acetonitrile was used as a solvent. A binder was not used.

First, PEO and LiFSI were weighed such that the ratio of PEO to LiFSI becomes 1:0.25 (weight ratio), and dissolved in acetonitrile. AB was added to this solution, and the solution was mixed at 1500 rpm for one minute in a planetary centrifugal mixer (Awatori Rentaro, produced by THINKY CORPORATION). Then, LCO was added and mixed at 1500 rpm for one minute. The one-minute mixture at 1500 rpm was repeated another four times to form a slurry. The mixture ratio of LCO to AB and (PEO+LiFSI) was 82:5:13 (weight ratio).

The slurry was applied to a piece of aluminum foil (20 µm in thickness, without an undercoat). Then, the solvent was evaporated in a circulation drying oven (at 80° C. for one hour). Through the above process, the positive electrode was obtained. The carried amount of the positive electrode was approximately 7 mg/cm², and the thickness of the positive electrode active material layer was approximately 46 µm.

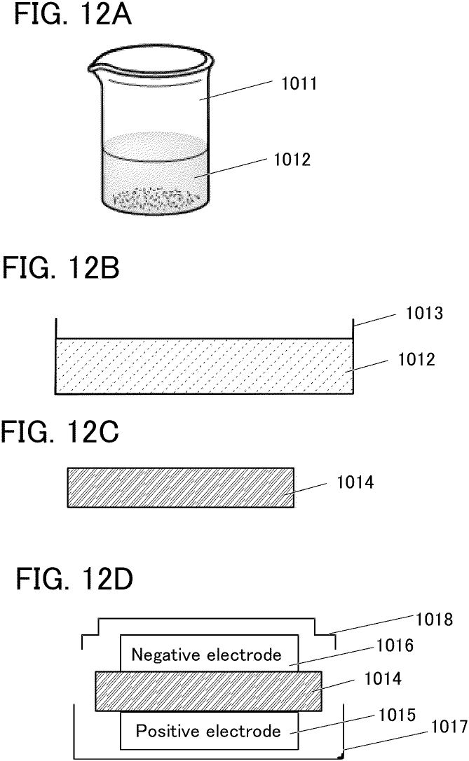

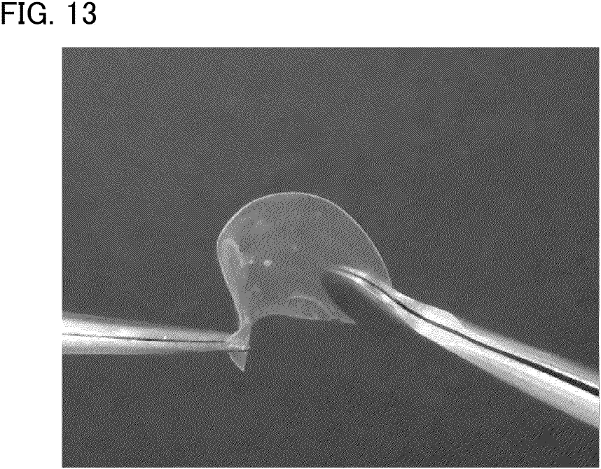

The electrolyte layer was fabricated as follows. The fabrication method will be described with reference to FIG. 12A, FIG. 12B, and FIG. 12C. PEO (with a molecular weight of approximately 200,000, produced by ACROS ORGANICS) was used as a lithium-ion conductive polymer, and LiFSI was used as a lithium salt. Weighing out 1 g of PEO and 0.25 g of LiFSI, the PEO and LiFSI were dissolved in 20 ml of acetonitrile in a container 1011. A solution 1012 in the container 1011 illustrated in FIG. 12A was poured into a fluororesin petri dish 1013 with a diameter of 10 cm illustrated in FIG. 12B and dried at 70° C.; then, a mixture remaining at the bottom of the fluororesin petri dish 1013 was peeled off. The mixture was dried all night under reduced pressure, and then dried at 90° C. for three hours under reduced pressure. The resulting object was an electrolyte layer 1014. FIG. 13 is a photograph of the electrolyte layer being picked up with tweezers. As shown in FIG. 13, the obtained electrolyte layer was flexible. A shape with a diameter of approximately 20 mm was punched out from the electrolyte layer 1014 with a diameter of 10 cm, which was used as a sample as illustrated in FIG. 12C.

Metallic lithium was used for a negative electrode.

With the use of the above positive electrode 1015, the electrolyte layer 1014, and the negative electrode 1016, a coin-type battery cell of CR2032 type (with a diameter of 20 mm and a height of 3.2 mm) was fabricated. FIG. 12D is a cross-sectional view of the coin-type battery cell. As illustrated in FIG. 12D, a stack including the positive electrode 1015, the electrolyte layer 1014, and the negative electrode 1016 is placed between a positive electrode can 1017 and a negative electrode can 1018. The positive electrode can 1017 and the negative electrode can 1018, formed of stainless steel (SUS), were used. Although a washer, a gasket, a spacer, and the like are not illustrated in FIG. 12D, the fabricated coin-type battery cell has a cross-sectional structure which is almost the same as that of the battery cell illustrated in FIG. 4B.

After fabricated, the coin cell was left in a constant temperature bath at 85° C. without charge and discharge for one hour, in order for the positive electrode 1015, the electrolyte layer 1014, and the negative electrode 1016 to be adhered to one another. This was Sample 1.

Next, as a comparative example, a secondary battery that does not contain a lithium-ion conductive polymer and a lithium salt in the positive electrode active material layer was fabricated.

A positive electrode of the comparative example was fabricated in the following manner. As a positive electrode active material, a lithium cobalt oxide (LCO) was used. As the conductive material, acetylene black (AB) was used. As a binder, polyvinylidene fluoride (PVDF) was used. A slurry was formed such that the mixture ratio of LCO to AB and PVDF becomes 95:3:2 by weight. The slurry was applied to a piece of aluminum foil and dried. After that, pressure was applied at 210 kN/m, and then pressure was applied at 1467 kN/m. The carried amount of the positive electrode was approximately 7 mg/cm², and the thickness of the positive electrode active material layer was approximately 19 µm.

An electrolyte layer, a negative electrode, and a coin cell that are similar to those of Sample 1 were used. The comparative example was not put in a constant temperature bath at 85° C. This was Sample 2 (comparative example).

Table 1 shows the fabrication conditions of Samples 1 and Sample 2. Table 1 Positive electrode active material layer Electrolyte layer NegativeElectrode mixture ratio (wt) mixture ratio (wt) electrode Sample 1 LCO:AB:(PEO+LiFSI) = 82:5:13 PEO:LiFSI = 1:0.25 Li Sample 2 (comparative LCO:AB:PVDF = 95:3:2 PEO:LiFSI = 1:0.25 Li example)

| | Positive electrode active material layer mixture ratio (wt) | Electrolyte layer mixture ratio (wt) | Negative electrode |
|---|---|---|---|
| Sample 1 | LCO:AB:(PEO+LiFSI) = 82:5:13 | PEO:LiFSI = 1:0.25 | Li |
| Sample 2 (comparative example) | LCO:AB:PVDF = 95:3:2 | PEO:LiFSI = 1:0.25 | Li |

### Cross-Sectional SEM

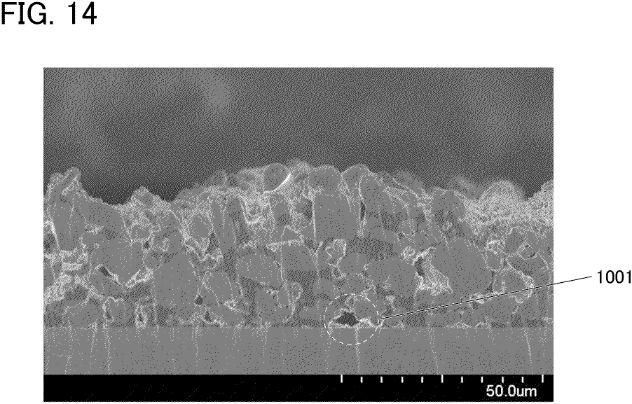

FIG. 14 shows a cross-sectional SEM image of the positive electrode of Sample 1. Although a void 1001 was observed in a certain portion as indicated by a white dashed line in FIG. 14, the number and volume of the void 1001 were small, which demonstrated that a good positive electrode was fabricated.

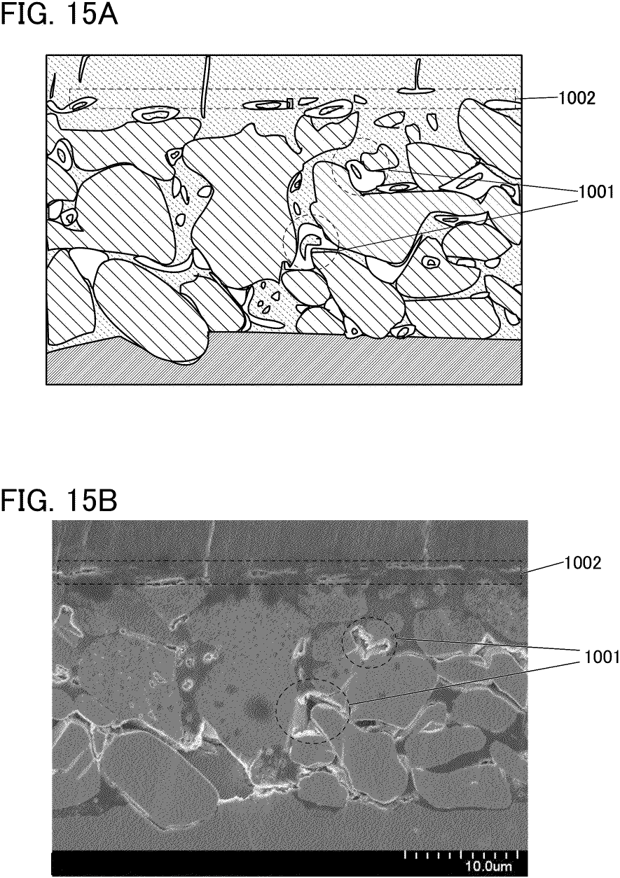

FIG. 15A is a cross-sectional view of the positive electrode and the electrolyte layer of Sample 2, and FIG. 15B shows a cross-sectional SEM image of the positive electrode and the electrolyte layer of Sample 2. An interface region 1002 between the positive electrode active material layer and the electrolyte layer is indicated by a dashed line. A number of large voids 1001 were observed in Sample 2 where the binder (PVDF) was used at the time of fabricating the positive electrode active material layer, whereas the number and volume of voids in the positive electrode active material layer were small in Sample 1 where PEO was used at the time of fabricating the positive electrode active material layer and a binder was not used. Reduction in voids was achieved in Sample 1, although Sample 1 was in a condition before the electrolyte layer is placed thereover.

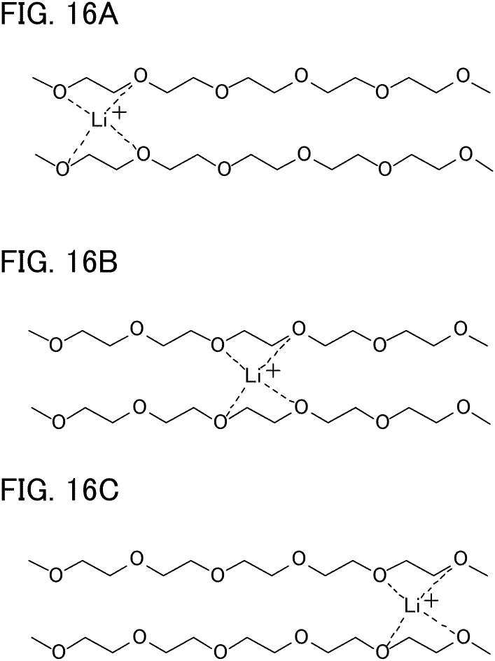

Lithium ion conduction in PEO used for the electrolyte layer is shown in FIG. 16A, FIG. 16B, and FIG. 16C. FIG. 16A, FIG. 16B, and FIG. 16C are shown in a chronological sequence. As shown in FIG. 16A, FIG. 16B, and FIG. 16C, lithium ions move by changing oxygen to interact with, due to partial movement (segmental motion) of ether chains (oxygen atoms) of polymer. Thus, the conductivity of lithium ions increases as the temperature rises. Note that although PEO molecules are simplified and illustrated in a linear form in FIG. 16A to FIG. 16C, the actual PEO molecules are intricately curved. Even with the ether chains intricately curved, lithium ions move by changing oxygen to interact with, due to partial movement (segmental motion).

### Charge and Discharge Characteristics

Charge and discharge characteristics of secondary batteries of Sample 1 and Sample 2, which were fabricated in the above manner, were evaluated. CC/CV charging (0.1 C, 4.0 V, 0.01 C cut) and CC discharging (0.1 C, 2.5 V cut) were performed, and a 10-minute break was taken before the next charging. The measurement temperature was set to 60° C. Note that 1 C was 200 mA/g in this example and the like.

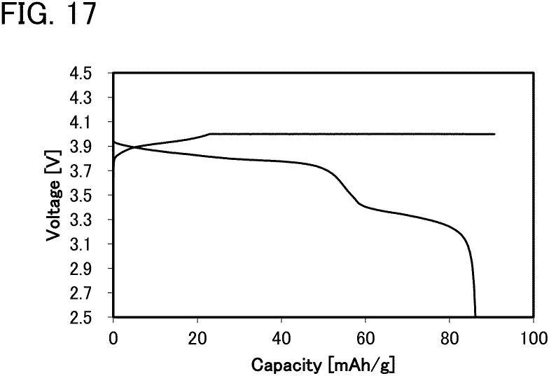

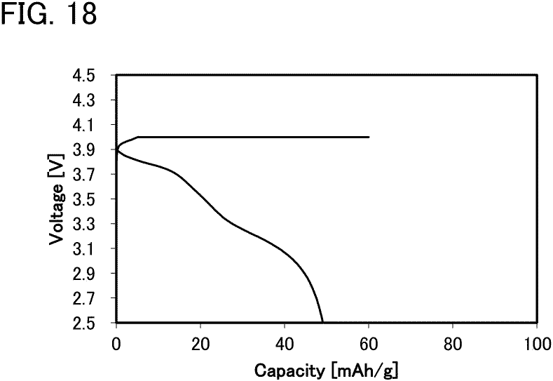

Initial charge and discharge curves of Sample 1 and Sample 2 are shown in FIG. 17 and FIG. 18, respectively. The discharge capacity of Sample 1 was 86 mAh/g, and the discharge capacity of Sample 2 was 49 mAh/g.

The discharge capacity per weight of the active material was larger in Sample 1 where PEO and LiFSI were mixed in the positive electrode active material layer than in Sample 2 where PEO and LiFSI were not mixed. The above demonstrates that inclusion of an electrolyte inside the positive electrode enables the active material and the electrolyte inside the positive electrode to contact with each other and the active material inside to contribute to charge and discharge. Furthermore, it was found that inclusion of an electrolyte in the active material layer improves discharge capacity of the secondary battery.

### Example 2

In this example, secondary batteries with a positive electrode active material layer including a lithium-ion conductive polymer and a lithium salt, which are each one embodiment of the present invention, were fabricated; one of them used acetylene black as a conductive material, and the other used graphene as a conductive material. Then, their characteristics were evaluated.

### Fabrication of Secondary Batteries

A secondary battery was fabricated, as Sample 3, in the same way as Sample 1 of Example 1 except that the positive electrode mixture ratio of LCO to AB and (PEO+LiFSI) was 90:5:5 (weight ratio). The carried amount of the positive electrode was approximately 2.5 mg/cm². In addition, a secondary battery in which graphene (A-12, produced by SuperMarket) was used in place of AB in Sample 3 was fabricated as Sample 4. The carried amount of the positive electrode was approximately 1.8 mg/cm².

The mixing conditions for positive electrodes and carried amounts of Sample 3 and Sample 4 are listed in Table 2.

TABLE 2

| | | |
|---|---|---|
| | Sample 3 | Sample 4 |
| Positive electrode active material | LCO 90 wt% | LCO 90 wt% |
| Conductive material | AB 5 wt% | Graphene 5 wt% |
| Semi-solid electrolyte | PEO+LiFSI 5 wt% | PEO+LiFSI 5 wt% |
| Carried amount | 2.5 mg/cm² | 1.8 mg/cm² |

### Charge and Discharge Characteristics

After the secondary batteries of Sample 3 and Sample 4 were subjected to one-hour aging at 85° C., their charge and discharge characteristics were evaluated. CC/CV charging (0.1 C, 4.0 V, 0.01 C cut) and CC discharging (0.1 C, 2.5 V cut) were performed, and a 10-minute break was taken before the next charging. The measurement temperature was set to 60° C. Note that 1 C was 200 mA/g in this example and the like.

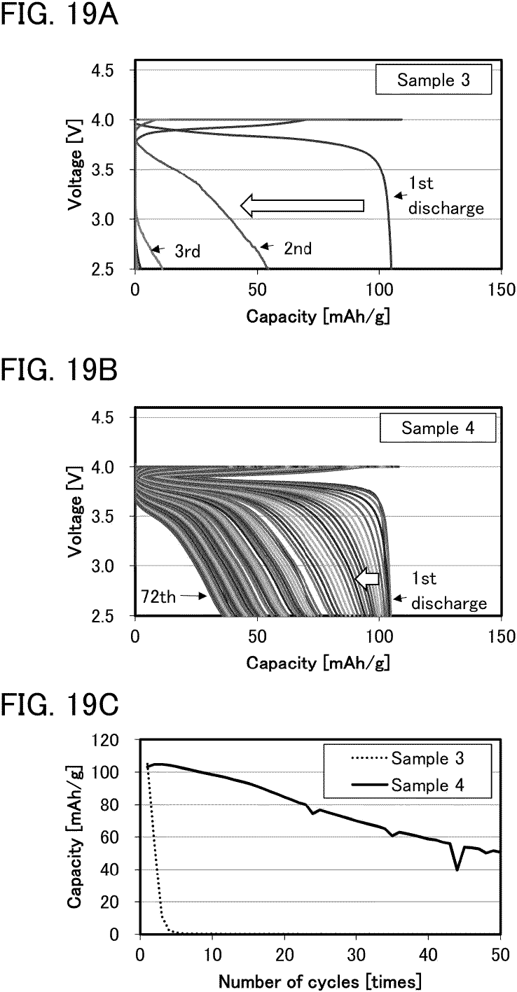

FIG. 19A shows charge and discharge curves of Sample 3, FIG. 19B shows charge and discharge curves of Sample 4, and FIG. 19C shows a graph of cycle performance of Sample 3 and Sample 4.

Discharge capacity of Sample 3 and Sample 4 decreased as they went through the charge and discharge cycles, as indicated by the arrow in FIG. 19A and FIG. 19B; however, Sample 4 with a discharge capacity of 35.9 mAh/g being obtained at the 72nd discharge exhibited excellent cycle performance, as compared to Sample 3 with a discharge capacity being dropped to 11.1 mAh/g at the 3rd discharge.

Based on the above, it was found that containing graphene as a conductive material can improve the charge and discharge cycle performance of a semi-solid battery.

### Fabrication of Secondary Batteries

A secondary battery was fabricated, as Sample 5, in the same way as Sample 3 except that the positive electrode mixture ratio of LCO to AB and (PEO+LiFSI) was 82:5:13 (weight ratio). The carried amount of the positive electrode was approximately 6.9 mg/cm². In addition, a secondary battery in which graphene was used in place of AB in Sample 5 was fabricated as Sample 6. The carried amount of the positive electrode was approximately 7.2 mg/cm².

The mixing conditions for positive electrodes and carried amounts of Sample 5 and Sample 6 are listed in Table 3.

TABLE 3

| | | |
|---|---|---|
| | Sample 5 | Sample 6 |
| Positive electrode active material | LCO 82 wt% | LCO 82 wt% |
| Conductive material | AB 5 wt% | Graphene 5 wt% |
| Semi-solid electrolyte | PEO+LiFSI 13 wt% | PEO+LiFSI 13 wt% |
| Carried amount | 6.9 mg/cm2 | 7.2 mg/cm2 |

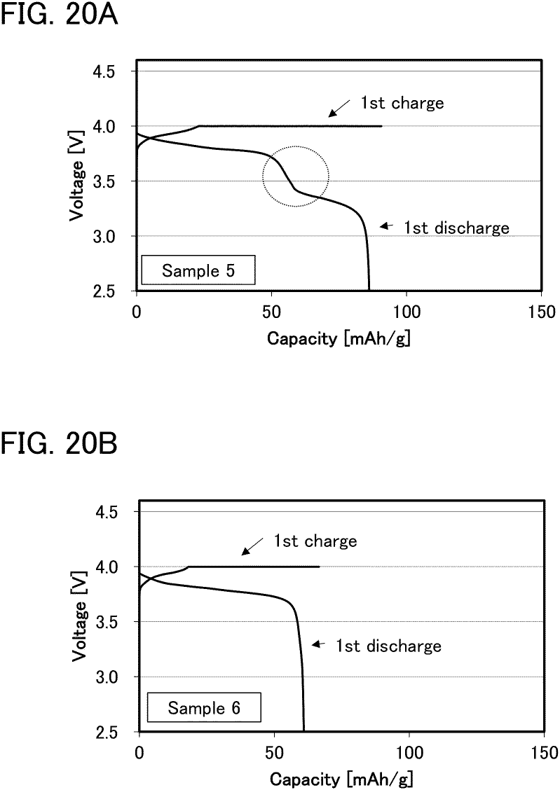

Charge and discharge characteristics of the secondary batteries of Sample 5 and Sample 6 were evaluated, in the same way as Sample 3 and Sample 4. FIG. 20A and FIG. 20B show graphs of the initial charge and discharge curves of Sample 5 and the initial charge and discharge curves of Sample 6, respectively.

For Sample 5 in which AB was used as the conductive material, a voltage drop which is likely attributable to resistance was observed, as indicated by a dashed circle in FIG. 20A. By contrast, for Sample 6 in which graphene was used, there was no voltage drop which is likely attributable to resistance, although the discharge capacity slightly decreased.

Based on the above, it was found that containing graphene as a conductive material can improve the charge and discharge characteristics of a semi-solid battery.

### Fabrication of Secondary Batteries

A secondary battery with the same positive electrode mixture ratio as that of Sample 5 was fabricated as Sample 7. The carried amount of the positive electrode was approximately 4.4 mg/cm². In addition, a secondary battery in which graphene was used in place of AB in Sample 7 was fabricated as Sample 8. The carried amount of the positive electrode was approximately 7.2 mg/cm².

The mixing conditions for positive electrodes and carried amounts of Sample 7 and Sample 8 are listed in Table 4.

TABLE 4

| | | |
|---|---|---|
| | Sample 7 | Sample 8 |
| Positive electrode active material | LCO 82 wt% | LCO 82 wt% |
| Conductive material | AB 5 wt% | Graphene 5 wt% |
| Semi-solid electrolyte | PEO+LiFSI 13 wt% | PEO+LiFSI 13 wt% |
| Carried amount | 4.4 mg/cm2 | 7.2 mg/cm2 |

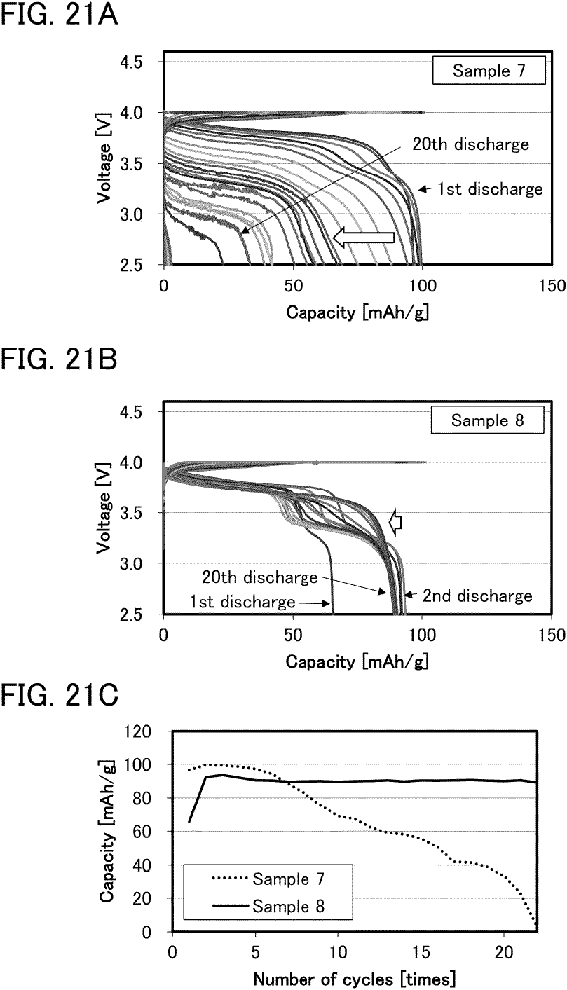

Charge and discharge cycle performance of the secondary batteries of Sample 7 and Sample 8 were evaluated, in the same way as Sample 3 and Sample 4. FIG. 21A shows charge and discharge curves of Sample 7, FIG. 21B shows charge and discharge curves of Sample 8, and FIG. 21C shows a graph of cycle performance of Sample 7 and Sample 8.

Sample 8 in which graphene was used as the conductive material exhibited better cycle performance than Sample 7 in which AB was used as the conductive material.

Furthermore, Sample 4 and Sample 8, each including graphene as the conductive material, exhibited substantially comparable charge and discharge cycle performance, even though there was a fourfold difference in carried amount between Sample 4 and Sample 8. The 20th discharge capacity of Sample 4 was 84.7 mAh/g, whereas that of Sample 8 was 90.0 mAh/g.

Based on the above, it was found that containing graphene as a conductive material can improve charge and discharge characteristics of a semi-solid battery while increasing the carried amount of a positive electrode.

### Reference Numerals

100: secondary battery, 101: positive electrode current collector, 102: positive electrode active material layer, 103: electrolyte layer, 104: negative electrode active material layer, 105: negative electrode current collector, 106: positive electrode, 107: negative electrode, 110: electrolyte, 111: positive electrode active material, 113: negative electrode active material, 115: inorganic filler, 120: graphene and graphene compound, 120a: graphene and graphene compound, 300: secondary battery, 301: positive electrode can, 302: negative electrode can, 303: gasket, 304: positive electrode, 305: positive electrode current collector, 306: positive electrode active material layer, 307: negative electrode, 308: negative electrode current collector, 309: negative electrode active material layer, 310: electrolyte layer, 400: secondary battery, 401: wound body, 410: exterior body, 411: terminal, 412: terminal, 413: terminal, 414: terminal, 420: module, 421: battery controller, 422: protector, 700: secondary battery, 701: positive electrode current collector, 702: positive electrode active material layer, 703: positive electrode, 704: negative electrode current collector, 705: negative electrode active material layer, 706: negative electrode, 707: electrolyte layer, 709: exterior body, 720: power supply system, 721: commercial power source, 723: distribution board, 725: power storage controller, 726: indicator, 727: general load, 728: power storage load, 729: router, 730: service wire mounting portion, 731: measuring portion, 732: predicting portion, 733: planning portion, 790: control device, 791 power storage device, 796: underfloor space, 799: building, 1001: void, 1002: interface region, 1011: container, 1012: solution, 1013: fluororesin petri dish, 1014: electrolyte layer, 1015: positive electrode, 1016: negative electrode, 1017: positive electrode can, 1018: negative electrode can, 1300: rectangular secondary battery, 1301a: battery, 1301b: battery, 1302: battery controller, 1303: motor controller, 1304: motor, 1305: gear, 1306: DCDC circuit, 1307: electric power steering, 1308: heater, 1309: defogger, 1310: DCDC circuit, 1311: battery, 1312: inverter, 1313: audio, 1314: power window, 1315: lamps, 1316: tire, 1317: rear motor, 1320: control circuit portion, 1321: control circuit portion, 1322: control circuit, 1324: switch portion, 1325: external terminal, 1326: external terminal, 1413: fixing portion, 1414: fixing portion, 1415: battery pack, 1421: wiring, 1422: wiring, 2001: automobile, 2002: transporter, 2003: transportation vehicle, 2004: aircraft, 2100: mobile phone, 2101: housing, 2102: display portion, 2103: operation button, 2104: external connection port, 2105: speaker, 2106: microphone, 2107: secondary battery, 2200: battery pack, 2201: battery pack, 2202: battery pack, 2203: battery pack, 2300: unmanned aircraft, 2301: secondary battery, 2302: rotor, 2303: camera, 2603: vehicle, 2604: charging device, 2610: solar panel, 2611: wiring, 2612: power storage device, 8600: motor scooter, 8601: side mirror, 8602: power storage device, 8603: indicator light, 8604: storage unit under seat, 8700: electric bicycle, 8701: storage battery, 8702: power storage device, 8703: display portion, 8704: control circuit

1. A secondary battery comprising a positive electrode, a negative electrode, and an electrolyte layer between the positive electrode and the negative electrode,
wherein the positive electrode comprises a positive electrode active material, a first lithium-ion conductive polymer, a first lithium salt, and a first conductive material over a positive electrode current collector, and
wherein the electrolyte layer comprises a second lithium-ion conductive polymer and a second lithium salt.

2. The secondary battery according to claim 1, wherein at least one of the first lithium-ion conductive polymer and the second lithium-ion conductive polymer is polyethylene oxide.

3. The secondary battery according to claim 1, wherein at least one of the first lithium salt and the second lithium salt comprises lithium, sulfur, fluorine, and nitrogen.

4. The secondary battery according to claim 1,
wherein the electrolyte layer comprises an inorganic filler, and
wherein the inorganic filler comprises aluminum oxide, titanium oxide, barium titanate, silicon oxide, lanthanum lithium titanate, lanthanum lithium zirconate, zirconium oxide, yttria-stabilized zirconia, lithium niobate, or lithium phosphate.

5. The secondary battery according to claim 1, wherein the negative electrode comprises a negative electrode active material, a third lithium-ion conductive polymer, a third lithium salt, and a second conductive material over a negative electrode current collector.

6. The secondary battery according to claim 1, wherein at least one of the first conductive material and the second conductive material is graphene.

7. The secondary battery according to claim 1, wherein the negative electrode active material comprises silicon nanoparticles.

8. An electronic device comprising the secondary battery according to claim 1.

9. A vehicle comprising the secondary battery according to claim 1.

10. A method for manufacturing an electrode comprising:
forming a slurry comprising a lithium-ion conductive polymer, a lithium salt, a conductive material, and an active material; and
applying the slurry to a current collector and then drying the slurry.

11. A method for manufacturing a secondary battery comprising steps of:
forming a first slurry comprising a first lithium-ion conductive polymer, a first lithium salt, a first conductive material, and a positive electrode active material;
forming a positive electrode by applying the slurry to a positive electrode current collector and then drying the slurry;
pouring a mixture comprising a second lithium-ion conductive polymer, a second lithium salt, and a solvent, into a container;
forming an electrolyte layer by heating the container comprising the mixture and then drying the mixture,
forming a second slurry comprising a third lithium-ion conductive polymer, a third lithium salt, a second conductive material, and a negative electrode active material;
forming a negative electrode by applying the second slurry to a negative electrode current collector and then drying the second slurry; and
placing the negative electrode over the positive electrode with the electrolyte layer therebetween.

12. The secondary battery according to claim 5, wherein the third lithium-ion conductive polymer is polyethylene oxide.

13. The secondary battery according to claim 5, wherein the third lithium salt comprises lithium, sulfur, fluorine, and nitrogen.
